(19) United States
(12) Patent Application Publication
(10) Pub. No.: US 2021/0135713 A1
(43) Pub. Date: May 6, 2021

(54) METHOD AND APPARATUS FOR PERFORMING BEAM FAILURE RECOVERY IN WIRELESS COMMUNICATION SYSTEM

(71) Applicant: LG ELECTRONICS INC., Seoul (KR)

(72) Inventors: Jiwon KANG, Seoul (KR); Eunjong LEE, Seoul (KR)

(73) Assignee: LG ELECTRONICS INC., Seoul (KR)

(21) Appl. No.: 17/251,132

(22) PCT Filed: Jun. 21, 2019
(86) PCT No.: PCT/KR2019/007547

§ 371 Date: Dec. 10, 2020

Related U.S. Application Data
(60) Provisional application No. 62/716,342, filed on Aug. 8, 2018.

(30) Foreign Application Priority Data
Jun. 21, 2018 (KR) 10-2018-0071630

(51) Int. Cl. H04B 7/0408; H04W 72/04; H04W 72/08

(52) U.S. Cl. CPC H04B 7/0408; H04W 72/085; H04W 72/046

(57) ABSTRACT

According to an embodiment of the disclosure, a method for performing beam failure recovery by a terminal in a wireless communication system comprises the steps of: transmitting, by the terminal in a beam failure situation, a beam failure recovery request to a base station; and performing beam failure recovery by monitoring a response to the beam failure recovery request, wherein whether to stop the step of performing beam failure recovery is determined by monitoring of monitoring spaces set based on one or more control resource sets established for the terminal and the step of performing beam failure recovery is stopped when the beam quality for at least one of the one or more control resource sets, except for a control resource set that is established exclusively for beam failure recovery, satisfies a predetermined requirement.

### TECHNICAL FIELD

The disclosure relates to methods and devices for performing beam failure recovery in a wireless communication system.

### BACKGROUND ART

Mobile communication systems have been developed to provide voice services, while ensuring activity of users. However, coverage of the mobile communication systems has been extended up to data services, as well as voice service, and currently, an explosive increase in traffic has caused shortage of resources, and since users expect relatively high speed services, an advanced mobile communication system is required.

Requirements of a next-generation mobile communication system include accommodation of explosive data traffic, a significant increase in a transfer rate per user, accommodation of considerably increased number of connection devices, very low end-to-end latency, and high energy efficiency. To this end, there have been researched various technologies such as dual connectivity, massive multiple input multiple output (MIMO), in-band full duplex, non-orthogonal multiple access (NOMA), super wideband, device networking, and the like.

### DETAILED DESCRIPTION OF THE DISCLOSURE

### Technical Problem

An object of the disclosure is to adaptively perform a beam failure recovery procedure according to the quality of a beam monitored after beam failure detection.

Another object of the disclosure is to more accurately determine whether the quality of existing beams is restored by monitoring the quality of the beam.

Another object of the disclosure is to monitor the quality of the beam so as not to affect the performance of the beam failure recovery procedure.

Objects of the disclosure are not limited to the foregoing, and other unmentioned objects would be apparent to one of ordinary skill in the art from the following description.

### Technical Solution

According to an embodiment of the disclosure, a method for performing beam failure recovery by a user equipment (UE) in a wireless communication system comprises transmitting a beam failure recovery request to a base station by the UE in a beam failure situation and performing the beam failure recovery by monitoring a response to the beam failure recovery request, wherein whether to stop performing the beam failure recovery is determined by monitoring monitoring spaces configured based on one or more control resource sets configured for the UE, and wherein performing the beam failure recovery is stopped when a beam quality for at least one except for a control resource set configured only for beam failure recovery among the one or more control resource sets meets a predetermined requirement.

Whether to stop performing the beam failure recovery is determined when control information is received via any one of the one or more control resource sets.

The one or more control resource set configured for the UE are located in a search space other than a search space configured to detect the response to the beam failure recovery request signal from the base station.

The data is downlink control information.

A beam for at least one except for the control resource set configured only for the beam failure recovery among the one or more control resource sets is a beam corresponding to a control resource set receiving the control information, at least one beam among all beams corresponding to a control resource set configured before the beam failure, at least one beam among beams configured for beam failure detection, or a combination thereof.

The beam quality is a hypothetical block error rate (BLER).

The predetermined requirement is any one of 1) when the beam quality remains below a predetermined threshold for a predetermined time, 2) when the beam quality is detected as below the predetermined threshold continuously a predetermined number of times or more, or 3) when the beam quality is detected as below the predetermined threshold continuously the predetermined number of times or more within the predetermined time.

The predetermined time is shorter than a time set in a timer related to a radio link failure.

The monitoring for determining whether to stop performing the beam failure recovery is started at a time of detection of a beam failure, at a time of transmission of the beam failure recovery request, or a specific time after the time of detection or the time of transmission.

In performing the beam failure recovery, the response is monitored by performing blind detection on a search space configured to detect the beam failure, and the monitoring for determining whether to stop performing the beam failure recovery is performed by performing blind detection on search spaces other than the search space configured to detect the beam failure among search spaces configured in the UE.

A number of the search spaces where the blind detection is performed is limited to a predetermined value, and when the number of search spaces currently subject to blind detection exceeds the predetermined value, the blind detection may be performed preferentially on the search space configured to detect the beam failure.

In performing the beam failure recovery, if no response to the beam failure recovery request is received, the steps are repeatedly performed from transmitting the beam failure recovery request, and when the predetermined requirement is met, the step currently being performed is stopped.

According to another embodiment of the disclosure, a UE performing beam failure recovery in a wireless communication system comprises a transceiver transmitting/receiving a radio signal, a memory, and a processor connected with the transceiver and the memory, wherein the processor is configured to: transmit a beam failure recovery request to a base station in a beam failure situation, perform the beam failure recovery by monitoring a response to the beam failure recovery request, determine whether to stop performing the beam failure recovery by monitoring monitoring spaces configured based on one or more control resource sets configured for the UE, and stop performing the beam failure recovery when a beam quality for at least one except for a control resource set configured only for the beam failure recovery among the one or more control resource sets according to a result of the monitoring meets a predetermined requirement.

The processor is configured to determine whether to stop performing the beam failure recovery when control information is received via any one of the one or more control resource sets.

According to another embodiment of the disclosure, a device performing beam failure recovery in a wireless communication system comprises a memory and a processor connected with the memory, wherein the processor is configured to: transmit a beam failure recovery request to a base station in a beam failure situation, perform the beam failure recovery by monitoring a response to the beam failure recovery request, determine whether to stop performing the beam failure recovery by monitoring monitoring spaces configured based on one or more control resource sets configured for the UE, and stop performing the beam failure recovery when a beam quality for at least one except for a control resource set configured only for the beam failure recovery among the one or more control resource sets according to a result of the monitoring meets a predetermined requirement.

### Advantageous Effects

In the disclosure, when the quality of the existing beam is recovered after the beam failure, the current beam failure recovery procedure is stopped, and if not, the beam failure recovery procedure continues. Therefore, when the quality of the existing beam is recovered after the beam failure, the operation currently being performed for beam failure recovery is stopped, and thus power waste of the UE may be prevented.

Further, the disclosure performs blind detection on an existing search space to determine whether to recover the quality of a beam and additionally considers whether a hypothetical block error rate is not more than a preset threshold and satisfies a predetermined time and a predetermined number of times. Therefore, even when the quality of the beam is temporarily recovered, it is possible to prevent the beam failure recovery procedure from being stopped.

Further, in the disclosure, when the number of search spaces in which blind detection is performed is limited, blind detection is preferentially performed on a search space for monitoring a response to the beam failure recovery request. Therefore, since only blind detection for monitoring the quality of the beam is performed, it is possible to prevent a failure or delay in receipt of a response to the beam failure recovery request.

Effects of the disclosure are not limited to the foregoing, and other unmentioned effects would be apparent to one of ordinary skill in the art from the following description.

### BRIEF DESCRIPTION OF DRAWINGS

FIG. 1 illustrates an AI device 100 according to an embodiment of the disclosure.

FIG. 2 illustrates an AI server 200 according to an embodiment of the disclosure.

FIG. 3 illustrates an AI system 1 according to an embodiment of the disclosure.

FIG. 4 illustrates an example of an overall structure of a NR system to which a method proposed by the present specification is applicable.

FIG. 5 illustrates a relation between an uplink frame and a downlink frame in a wireless communication system to which a method proposed by the present specification is applicable.

FIG. 6 illustrates an example of a resource grid supported in a wireless communication system to which a method proposed by the present specification is applicable.

FIG. 7 illustrates examples of a resource grid per antenna port and numerology to which a method proposed by the present specification is applicable.

FIG. 8 illustrates an example of a block diagram of a transmitter consisting of an analog beamformer and an RF chain.

FIG. 9 illustrates an example of a block diagram of a transmitter consisting of a digital beamformer and an RF chain.

FIG. 10 illustrates an example of an analog beam scanning scheme.

FIG. 11 is a flowchart illustrating a beam failure recovery procedure.

FIG. 12 is a flowchart illustrating a beam failure recovery method according to an embodiment of the disclosure.

FIG. 13 is a flowchart illustrating a beam failure recovery method according to another embodiment of the disclosure.

FIG. 14 is a view illustrating a wireless communication device to which the methods proposed in the present specification may be applied according to another embodiment of the disclosure.

FIG. 15 is a block diagram illustrating a configuration of a wireless communication device to which the methods proposed in the disclosure are applicable.

[Mode for Carrying out the Disclosure]

Reference will now be made in detail to embodiments of the disclosure, examples of which are illustrated in the accompanying drawings. Wherever possible, the same reference numbers will be used throughout the drawings to refer to the same or like parts. In general, a suffix such as “module” and “unit” may be used to refer to elements or components. Use of such a suffix herein is merely intended to facilitate description of the disclosure, and the suffix itself is not intended to give any special meaning or function. It will be noted that a detailed description of known arts will be omitted if it is determined that the detailed description of the known arts can obscure the embodiments of the disclosure. The accompanying drawings are used to help easily understand various technical features and it should be understood that embodiments presented herein are not limited by the accompanying drawings. As such, the disclosure should be construed to extend to any alterations, equivalents and substitutes in addition to those which are particularly set out in the accompanying drawings.

In the specification, a base station means a terminal node of a network directly performing communication with a terminal. In the present document, specific operations described to be performed by the base station may be performed by an upper node of the base station in some cases. That is, it is apparent that in the network constituted by multiple network nodes including the base station, various operations performed for communication with the terminal may be performed by the base station or other network nodes other than the base station. A base station (BS) may be generally substituted with terms such as a fixed station, Node B, evolved-NodeB (eNB), a base transceiver system (BTS), an access point (AP), and the like. Further, a ‘terminal’ may be fixed or movable and be substituted with terms such as user equipment (UE), a mobile station (MS), a user terminal (UT), a mobile subscriber station (MSS), a subscriber station (SS), an advanced mobile station (AMS), a wireless terminal (WT), a Machine-Type Communication (MTC) device, a Machine-to-Machine (M2M) device, a Device-to-Device (D2D) device, and the like.

Hereinafter, a downlink means communication from the base station to the terminal and an uplink means communication from the terminal to the base station. In the downlink, a transmitter may be a part of the base station and a receiver may be a part of the terminal. In the uplink, the transmitter may be a part of the terminal and the receiver may be a part of the base station.

Specific terms used in the following description are provided to help appreciating the disclosure and the use of the specific terms may be modified into other forms within the scope without departing from the technical spirit of the disclosure.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), non-orthogonal multiple access (NOMA), and the like. The CDMA may be implemented by radio technology universal terrestrial radio access (UTRA) or CDMA2000. The TDMA may be implemented by radio technology such as Global System for Mobile communications (GSM)/General Packet Radio Service(GPRS)/Enhanced Data Rates for GSM Evolution (EDGE). The OFDMA may be implemented as radio technology such as IEEE 802.11(Wi-Fi), IEEE 802.16(WiMAX), IEEE 802-20, E-UTRA(Evolved UTRA), and the like. The UTRA is a part of a universal mobile telecommunication system (UMTS). 3rd generation partnership project (3GPP) long term evolution (LTE) as a part of an evolved UMTS (E-UMTS) using evolved-UMTS terrestrial radio access (E-UTRA) adopts the OFDMA in a downlink and the SC-FDMA in an uplink. LTE-advanced (A) is an evolution of the 3GPP LTE.

The embodiments of the disclosure may be based on standard documents disclosed in at least one of IEEE 802, 3GPP, and 3GPP2 which are the wireless access systems. That is, steps or parts which are not described to definitely show the technical spirit of the disclosure among the embodiments of the disclosure may be based on the documents. Further, all terms disclosed in the document may be described by the standard document.

3GPP LTE/LTE-A/NR is primarily described for clear description, but technical features of the disclosure are not limited thereto.

Three major requirement areas of 5G include (1) an enhanced mobile broadband (eMBB) area, (2) a massive machine type communication (mMTC) area and (3) an ultra-reliable and low latency communications (URLLC) area.

Some use cases may require multiple areas for optimization, and other use case may be focused on only one key performance indicator (KPI). 5G support such various use cases in a flexible and reliable manner.

eMBB is far above basic mobile Internet access and covers media and entertainment applications in abundant bidirectional tasks, cloud or augmented reality. Data is one of key motive powers of 5G, and dedicated voice services may not be first seen in the 5G era. In 5G, it is expected that voice will be processed as an application program using a data connection simply provided by a communication system. Major causes for an increased traffic volume include an increase in the content size and an increase in the number of applications that require a high data transfer rate. Streaming service (audio and video), dialogue type video and mobile Internet connections will be used more widely as more devices are connected to the Internet. Such many application programs require connectivity always turned on in order to push real-time information and notification to a user. A cloud storage and application suddenly increases in the mobile communication platform, and this may be applied to both business and entertainment. Furthermore, cloud storage is a special use case that tows the growth of an uplink data transfer rate. 5G is also used for remote business of cloud. When a tactile interface is used, further lower end-to-end latency is required to maintain excellent user experiences. Entertainment, for example, cloud game and video streaming are other key elements which increase a need for the mobile broadband ability. Entertainment is essential in the smartphone and tablet anywhere including high mobility environments, such as a train, a vehicle and an airplane. Another use case is augmented reality and information search for entertainment. In this case, augmented reality requires very low latency and an instant amount of data.

Furthermore, one of the most expected 5G use case relates to a function capable of smoothly connecting embedded sensors in all fields, that is, mMTC. Until 2020, it is expected that potential IoT devices will reach 20.4 billions. The industry IoT is one of areas in which 5G performs major roles enabling smart city, asset tracking, smart utility, agriculture and security infra.

URLLC includes a new service which will change the industry through remote control of major infra and a link having ultra-reliability/low available latency, such as a self-driving vehicle. A level of reliability and latency is essential for smart grid control, industry automation, robot engineering, drone control and adjustment.

Multiple use cases are described more specifically.

5G may supplement fiber-to-the-home (FTTH) and cable-based broadband (or DOCSIS) as means for providing a stream evaluated from gigabits per second to several hundreds of mega bits per second. Such fast speed is necessary to deliver TV with resolution of 4K or more (6K, 8K or more) in addition to virtual reality and augmented reality. Virtual reality (VR) and augmented reality (AR) applications include immersive sports games. A specific application program may require a special network configuration. For example, in the case of VR game, in order for game companies to minimize latency, a core server may need to be integrated with the edge network server of a network operator.

An automotive is expected to be an important and new motive power in 5G, along with many use cases for the mobile communication of an automotive. For example, entertainment for a passenger requires a high capacity and a high mobility mobile broadband at the same time. The reason for this is that future users continue to expect a high-quality connection regardless of their location and speed. Another use example of the automotive field is an augmented reality dashboard. The augmented reality dashboard overlaps and displays information, identifying an object in the dark and notifying a driver of the distance and movement of the object, over a thing seen by the driver through a front window. In the future, a wireless module enables communication between automotives, information exchange between an automotive and a supported infrastructure, and information exchange between an automotive and other connected devices (e.g., devices accompanied by a pedestrian). A safety system guides alternative courses of a behavior so that a driver can drive more safely, thereby reducing a danger of an accident. A next step will be a remotely controlled or self-driven vehicle. This requires very reliable, very fast communication between different self-driven vehicles and between an automotive and infra. In the future, a self-driven vehicle may perform all driving activities, and a driver will be focused on things other than traffic, which cannot be identified by an automotive itself. Technical requirements of a self-driven vehicle require ultra-low latency and ultra-high speed reliability so that traffic safety is increased up to a level which cannot be achieved by a person.

A smart city and smart home mentioned as a smart society will be embedded as a high-density radio sensor network. The distributed network of intelligent sensors will identify the cost of a city or home and a condition for energy-efficient maintenance. A similar configuration may be performed for each home. All of a temperature sensor, a window and heating controller, a burglar alarm and home appliances are wirelessly connected. Many of such sensors are typically a low data transfer rate, low energy and a low cost. However, for example, real-time HD video may be required for a specific type of device for surveillance.

The consumption and distribution of energy including heat or gas are highly distributed and thus require automated control of a distributed sensor network. A smart grid collects information, and interconnects such sensors using digital information and a communication technology so that the sensors operate based on the information. The information may include the behaviors of a supplier and consumer, and thus the smart grid may improve the distribution of fuel, such as electricity, in an efficient, reliable, economical, production-sustainable and automated manner. The smart grid may be considered to be another sensor network having small latency.

A health part owns many application programs which reap the benefits of mobile communication. A communication system can support remote treatment providing clinical treatment at a distant place. This helps to reduce a barrier for the distance and can improve access to medical services which are not continuously used at remote farming areas. Furthermore, this is used to save life in important treatment and an emergency condition. A radio sensor network based on mobile communication can provide remote monitoring and sensors for parameters, such as the heart rate and blood pressure.

Radio and mobile communication becomes increasingly important in the industry application field. Wiring requires a high installation and maintenance cost. Accordingly, the possibility that a cable will be replaced with reconfigurable radio links is an attractive opportunity in many industrial fields. However, to achieve the possibility requires that a radio connection operates with latency, reliability and capacity similar to those of the cable and that management is simplified. Low latency and a low error probability is a new requirement for a connection to 5G.

Logistics and freight tracking is an important use case for mobile communication, which enables the tracking inventory and packages anywhere using a location-based information system. The logistics and freight tracking use case typically requires a low data speed, but a wide area and reliable location information.

The disclosure described below can be implemented by combining or modifying respective embodiments to meet the above-described requirements of 5G.

The following describes in detail technical fields to which the disclosure described below is applicable.

Artificial Intelligence (AI)

Artificial intelligence means the field in which artificial intelligence or methodology capable of producing artificial intelligence is researched. Machine learning means the field in which various problems handled in the artificial intelligence field are defined and methodology for solving the problems are researched. Machine learning is also defined as an algorithm for improving performance of a task through continuous experiences for the task.

An artificial neural network (ANN) is a model used in machine learning, and is configured with artificial neurons (nodes) forming a network through a combination of synapses, and may mean the entire model having a problem-solving ability. The artificial neural network may be defined by a connection pattern between the neurons of different layers, a learning process of updating a model parameter, and an activation function for generating an output value.

The artificial neural network may include an input layer, an output layer, and optionally one or more hidden layers. Each layer includes one or more neurons. The artificial neural network may include a synapse connecting neurons. In the artificial neural network, each neuron may output a function value of an activation function for input signals, weight, and a bias input through a synapse.

A model parameter means a parameter determined through learning, and includes the weight of a synapse connection and the bias of a neuron. Furthermore, a hyper parameter means a parameter that needs to be configured prior to learning in the machine learning algorithm, and includes a learning rate, the number of times of repetitions, a mini-deployment size, and an initialization function.

An object of learning of the artificial neural network may be considered to determine a model parameter that minimizes a loss function. The loss function may be used as an index for determining an optimal model parameter in the learning process of an artificial neural network.

Machine learning may be classified into supervised learning, unsupervised learning, and reinforcement learning based on a learning method.

Supervised learning means a method of training an artificial neural network in the state in which a label for learning data has been given. The label may mean an answer (or a result value) that must be deduced by an artificial neural network when learning data is input to the artificial neural network. Unsupervised learning may mean a method of training an artificial neural network in the state in which a label for learning data has not been given. Reinforcement learning may mean a learning method in which an agent defined within an environment is trained to select a behavior or behavior sequence that maximizes accumulated compensation in each state.

Machine learning implemented as a deep neural network (DNN) including a plurality of hidden layers, among artificial neural networks, is also called deep learning. Deep learning is part of machine learning. Hereinafter, machine learning is used as a meaning including deep learning.

Robot

A robot may mean a machine that automatically processes a given task or operates based on an autonomously owned ability. Particularly, a robot having a function for recognizing an environment and autonomously determining and performing an operation may be called an intelligence type robot.

A robot may be classified for industry, medical treatment, home, and military based on its use purpose or field.

A robot includes a driving unit including an actuator or motor, and may perform various physical operations, such as moving a robot joint. Furthermore, a movable robot includes a wheel, a brake, a propeller, etc. in a driving unit, and may run on the ground or fly in the air through the driving unit.

Self-Driving (Autonomous-Driving)

Self-driving means a technology for autonomous driving. A self-driving vehicle means a vehicle that runs without a user manipulation or by a user's minimum manipulation.

For example, self-driving may include all of a technology for maintaining a driving lane, a technology for automatically controlling speed, such as adaptive cruise control, a technology for automatic driving along a predetermined path, a technology for automatically configuring a path when a destination is set and driving.

A vehicle includes all of a vehicle having only an internal combustion engine, a hybrid vehicle including both an internal combustion engine and an electric motor, and an electric vehicle having only an electric motor, and may include a train, a motorcycle, etc. in addition to the vehicles.

In this case, the self-driving vehicle may be considered to be a robot having a self-driving function.

Extended Reality (XR)

Extended reality collectively refers to virtual reality (VR), augmented reality (AR), and mixed reality (MR). The VR technology provides an object or background of the real world as a CG image only. The AR technology provides a virtually produced CG image on an actual thing image. The MR technology is a computer graphics technology for mixing and combining virtual objects with the real world and providing them.

The MR technology is similar to the AR technology in that it shows a real object and a virtual object. However, in the AR technology, a virtual object is used in a form to supplement a real object. In contrast, unlike in the AR technology, in the MR technology, a virtual object and a real object are used as the same character.

The XR technology may be applied to a head-mount display (HMD), a head-up display (HUD), a mobile phone, a tablet PC, a laptop, a desktop, TV, and a digital signage. A device to which the XR technology has been applied may be called an XR device.

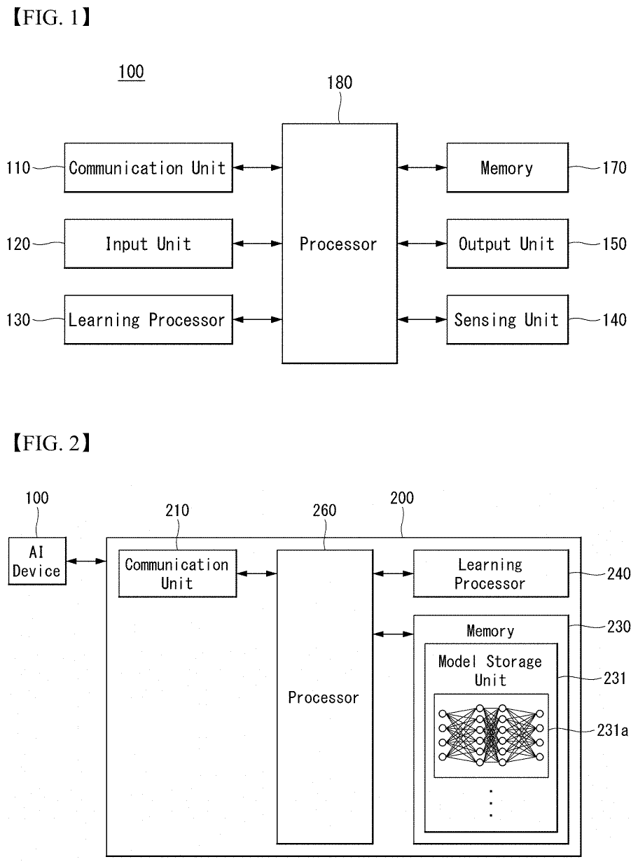

FIG. 1 illustrates an AI device 100 according to an embodiment of the disclosure.

The AI device 100 may be implemented as a fixed device or mobile device, such as TV, a projector, a mobile phone, a smartphone, a desktop computer, a notebook, a terminal for digital broadcasting, a personal digital assistants (PDA), a portable multimedia player (PMP), a navigator, a tablet PC, a wearable device, a set-top box (STB), a DMB receiver, a radio, a washing machine, a refrigerator, a desktop computer, a digital signage, a robot, and a vehicle.

Referring to FIG. 1, the terminal 100 may include a communication unit 110, an input unit 120, a learning processor 130, a sensing unit 140, an output unit 150, a memory 170 and a processor 180.

The communication unit 110 may transmit and receive data to and from external devices, such as other AI devices 100a to 100er or an AI server 200, using wired and wireless communication technologies. For example, the communication unit 110 may transmit and receive sensor information, a user input, a learning model, and a control signal to and from external devices.

In this case, communication technologies used by the communication unit 110 include a global system for mobile communication (GSM), code division multi access (CDMA), long term evolution (LTE), 5G, a wireless LAN (WLAN), wireless-fidelity (Wi-Fi), Bluetooth™ radio frequency identification (RFID), infrared data association (IrDA), ZigBee, near field communication (NFC), etc.

The input unit 120 may obtain various types of data.

In this case, the input unit 120 may include a camera for an image signal input, a microphone for receiving an audio signal, a user input unit for receiving information from a user, etc. In this case, the camera or the microphone is treated as a sensor, and a signal obtained from the camera or the microphone may be called sensing data or sensor information.

The input unit 120 may obtain learning data for model learning and input data to be used when an output is obtained using a learning model. The input unit 120 may obtain not-processed input data. In this case, the processor 180 or the learning processor 130 may extract an input feature by performing pre-processing on the input data.

The learning processor 130 may be trained by a model configured with an artificial neural network using learning data. In this case, the trained artificial neural network may be called a learning model. The learning model is used to deduce a result value of new input data not learning data. The deduced value may be used as a base for performing a given operation.

In this case, the learning processor 130 may perform AI processing along with the learning processor 240 of the AI server 200.

In this case, the learning processor 130 may include memory integrated or implemented in the AI device 100. Alternatively, the learning processor 130 may be implemented using the memory 170, external memory directly coupled to the AI device 100 or memory maintained in an external device.

The sensing unit 140 may obtain at least one of internal information of the AI device 100, surrounding environment information of the AI device 100, or user information using various sensors.

In this case, sensors included in the sensing unit 140 include a proximity sensor, an illumination sensor, an acceleration sensor, a magnetic sensor, a gyro sensor, an inertia sensor, an RGB sensor, an IR sensor, a fingerprint recognition sensor, an ultrasonic sensor, a photo sensor, a microphone, LIDAR, and a radar.

The output unit 150 may generate an output related to a visual sense, an auditory sense or a tactile sense.

In this case, the output unit 150 may include a display unit for outputting visual information, a speaker for outputting auditory information, and a haptic module for outputting tactile information.

The memory 170 may store data supporting various functions of the AI device 100. For example, the memory 170 may store input data obtained by the input unit 120, learning data, a learning model, a learning history, etc.

The processor 180 may determine at least one executable operation of the AI device 100 based on information, determined or generated using a data analysis algorithm or a machine learning algorithm. Furthermore, the processor 180 may perform the determined operation by controlling elements of the AI device 100.

To this end, the processor 180 may request, search, receive, and use the data of the learning processor 130 or the memory 170, and may control elements of the AI device 100 to execute a predicted operation or an operation determined to be preferred, among the at least one executable operation.

In this case, if association with an external device is necessary to perform the determined operation, the processor 180 may generate a control signal for controlling the corresponding external device and transmit the generated control signal to the corresponding external device.

The processor 180 may obtain intention information for a user input and transmit user requirements based on the obtained intention information.

In this case, the processor 180 may obtain the intention information, corresponding to the user input, using at least one of a speech to text (STT) engine for converting a voice input into a text string or a natural language processing (NLP) engine for obtaining intention information of a natural language.

In this case, at least some of at least one of the STT engine or the NLP engine may be configured as an artificial neural network trained based on a machine learning algorithm. Furthermore, at least one of the STT engine or the NLP engine may have been trained by the learning processor 130, may have been trained by the learning processor 240 of the AI server 200 or may have been trained by distributed processing thereof.

The processor 180 may collect history information including the operation contents of the AI device 100 or the feedback of a user for an operation, may store the history information in the memory 170 or the learning processor 130, or may transmit the history information to an external device, such as the AI server 200. The collected history information may be used to update a learning model.

The processor 18 may control at least some of the elements of the AI device 100 in order to execute an application program stored in the memory 170. Moreover, the processor 180 may combine and drive two or more of the elements included in the AI device 100 in order to execute the application program.

FIG. 2 illustrates an AI server 200 according to an embodiment of the disclosure.

Referring to FIG. 2, the AI server 200 may mean a device which is trained by an artificial neural network using a machine learning algorithm or which uses a trained artificial neural network. In this case, the AI server 200 is configured with a plurality of servers and may perform distributed processing and may be defined as a 5G network. In this case, the AI server 200 may be included as a partial configuration of the AI device 100, and may perform at least some of AI processing.

The AI server 200 may include a communication unit 210, a memory 230, a learning processor 240 and a processor 260.

The communication unit 210 may transmit and receive data to and from an external device, such as the AI device 100.

The memory 230 may include a model storage unit 231. The model storage unit 231 may store a model (or artificial neural network 231a) which is being trained or has been trained through the learning processor 240.

The learning processor 240 may train the artificial neural network 231a using learning data. The learning model may be used in the state in which it has been mounted on the AI server 200 of the artificial neural network or may be mounted on an external device, such as the AI device 100, and used.

The learning model may be implemented as hardware, software or a combination of hardware and software. If some of or the entire learning model is implemented as software, one or more instructions configuring the learning model may be stored in the memory 230.

The processor 260 may deduce a result value of new input data using the learning model, and may generate a response or control command based on the deduced result value.

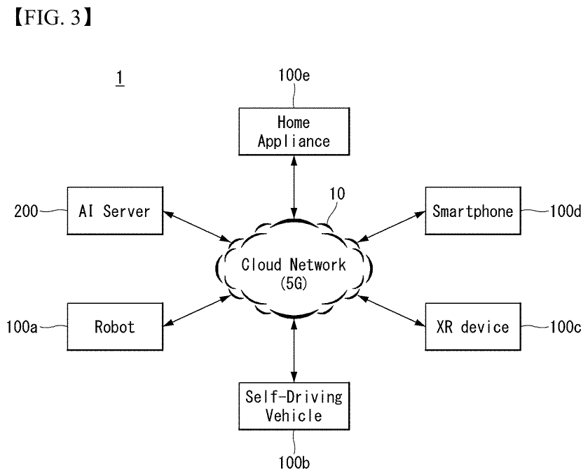

FIG. 3 illustrates an AI system 1 according to an embodiment of the disclosure.

Referring to FIG. 3, the AI system 1 is connected to at least one of the AI server 200, a robot 100a, a self-driving vehicle 100b, an XR device 100c, a smartphone 100d or home appliances 100e over a cloud network 10. In this case, the robot 100a, the self-driving vehicle 100b, the XR device 100c, the smartphone 100d or the home appliances 100e to which the AI technology has been applied may be called AI devices 100a to 100e.

The cloud network 10 may configure part of cloud computing infra or may mean a network present within cloud computing infra. In this case, the cloud network 10 may be configured using the 3G network, the 4G or long term evolution (LTE) network or the 5G network.

That is, the devices 100a to 100e (200) configuring the AI system 1 may be interconnected over the cloud network 10. Particularly, the devices 100a to 100e and 200 may communicate with each other through a base station, but may directly communicate with each other without the intervention of a base station.

The AI server 200 may include a server for performing AI processing and a server for performing calculation on big data.

The AI server 200 is connected to at least one of the robot 100a, the self-driving vehicle 100b, the XR device 100c, the smartphone 100d or the home appliances 100e, that is, AI devices configuring the AI system 1, over the cloud network 10, and may help at least some of the AI processing of the connected AI devices 100a to 100e.

In this case, the AI server 200 may train an artificial neural network based on a machine learning algorithm in place of the AI devices 100a to 100e, may directly store a learning model or may transmit the learning model to the AI devices 100a to 100e.

In this case, the AI server 200 may receive input data from the AI devices 100a to 100e, may deduce a result value of the received input data using the learning model, may generate a response or control command based on the deduced result value, and may transmit the response or control command to the AI devices 100a to 100e.

Alternatively, the AI devices 100a to 100e may directly deduce a result value of input data using a learning model, and may generate a response or control command based on the deduced result value.

Hereinafter, various embodiments of the AI devices 100a to 100e to which the above-described technology is applied are described. In this case, the AI devices 100a to 100e shown in FIG. 3 may be considered to be detailed embodiments of the AI device 100 shown in FIG. 1.

AI+Robot to which the Disclosure can be Applied

An AI technology is applied to the robot 100a, and the robot 100a may be implemented as a guidance robot, a transport robot, a cleaning robot, a wearable robot, an entertainment robot, a pet robot, an unmanned flight robot, etc.

The robot 100a may include a robot control module for controlling an operation. The robot control module may mean a software module or a chip in which a software module has been implemented using hardware.

The robot 100a may obtain state information of the robot 100a, may detect (recognize) a surrounding environment and object, may generate map data, may determine a moving path and a running plan, may determine a response to a user interaction, or may determine an operation using sensor information obtained from various types of sensors.

In this case, the robot 100a may use sensor information obtained by at least one sensor among LIDAR, a radar, and a camera in order to determine the moving path and running plan.

The robot 100a may perform the above operations using a learning model configured with at least one artificial neural network. For example, the robot 100a may recognize a surrounding environment and object using a learning model, and may determine an operation using recognized surrounding environment information or object information. In this case, the learning model may have been directly trained in the robot 100a or may have been trained in an external device, such as the AI server 200.

In this case, the robot 100a may directly generate results using the learning model and perform an operation, but may perform an operation by transmitting sensor information to an external device, such as the AI server 200, and receiving results generated in response thereto.

The robot 100a may determine a moving path and running plan using at least one of map data, object information detected from sensor information, or object information obtained from an external device. The robot 100a may run along the determined moving path and running plan by controlling the driving unit.

The map data may include object identification information for various objects disposed in the space in which the robot 100a moves. For example, the map data may include object identification information for fixed objects, such as a wall and a door, and movable objects, such as a flowport and a desk. Furthermore, the object identification information may include a name, a type, a distance, a location, etc.

Furthermore, the robot 100a may perform an operation or run by controlling the driving unit based on a user's control/interaction. In this case, the robot 100a may obtain intention information of an interaction according to a user's behavior or voice speaking, may determine a response based on the obtained intention information, and may perform an operation.

AI+Self-Driving to which the Disclosure can be Applied

An AI technology is applied to the self-driving vehicle 100b, and the self-driving vehicle 100b may be implemented as a movable type robot, a vehicle, an unmanned flight body, etc.

The self-driving vehicle 100b may include a self-driving control module for controlling a self-driving function. The self-driving control module may mean a software module or a chip in which a software module has been implemented using hardware. The self-driving control module may be included in the self-driving vehicle 100b as an element of the self-driving vehicle 100b, but may be configured as separate hardware outside the self-driving vehicle 100b and connected to the self-driving vehicle 100b.

The self-driving vehicle 100b may obtain state information of the self-driving vehicle 100b, may detect (recognize) a surrounding environment and object, may generate map data, may determine a moving path and running plan, or may determine an operation using sensor information obtained from various types of sensors.

In this case, in order to determine the moving path and running plan, like the robot 100a, the self-driving vehicle 100b may use sensor information obtained from at least one sensor among LIDAR, a radar and a camera.

Particularly, the self-driving vehicle 100b may recognize an environment or object in an area whose view is blocked or an area of a given distance or more by receiving sensor information for the environment or object from external devices, or may directly receive recognized information for the environment or object from external devices.

The self-driving vehicle 100b may perform the above operations using a learning model configured with at least one artificial neural network. For example, the self-driving vehicle 100b may recognize a surrounding environment and object using a learning model, and may determine the flow of running using recognized surrounding environment information or object information. In this case, the learning model may have been directly trained in the self-driving vehicle 100b or may have been trained in an external device, such as the AI server 200.

In this case, the self-driving vehicle 100b may directly generate results using the learning model and perform an operation, but may perform an operation by transmitting sensor information to an external device, such as the AI server 200, and receiving results generated in response thereto.

The self-driving vehicle 100b may determine a moving path and running plan using at least one of map data, object information detected from sensor information or object information obtained from an external device. The self-driving vehicle 100b may run based on the determined moving path and running plan by controlling the driving unit.

The map data may include object identification information for various objects disposed in the space (e.g., road) in which the self-driving vehicle 100b runs. For example, the map data may include object identification information for fixed objects, such as a streetlight, a rock, and a building, etc., and movable objects, such as a vehicle and a pedestrian. Furthermore, the object identification information may include a name, a type, a distance, a location, etc.

Furthermore, the self-driving vehicle 100b may perform an operation or may run by controlling the driving unit based on a user's control/interaction. In this case, the self-driving vehicle 100b may obtain intention information of an interaction according to a user' behavior or voice speaking, may determine a response based on the obtained intention information, and may perform an operation.

AI+XR to which the Disclosure can be Applied

An AI technology is applied to the XR device 100c, and the XR device 100c may be implemented as a head-mount display, a head-up display provided in a vehicle, television, a mobile phone, a smartphone, a computer, a wearable device, home appliances, a digital signage, a vehicle, a fixed type robot or a movable type robot.

The XR device 100c may generate location data and attributes data for three-dimensional points by analyzing three-dimensional point cloud data or image data obtained through various sensors or from an external device, may obtain information on a surrounding space or real object based on the generated location data and attributes data, and may output an XR object by rendering the XR object. For example, the XR device 100c may output an XR object, including additional information for a recognized object, by making the XR object correspond to the corresponding recognized object.

The XR device 100c may perform the above operations using a learning model configured with at least one artificial neural network. For example, the XR device 100c may recognize a real object in three-dimensional point cloud data or image data using a learning model, and may provide information corresponding to the recognized real object. In this case, the learning model may have been directly trained in the XR device 100c or may have been trained in an external device, such as the AI server 200.

In this case, the XR device 100c may directly generate results using a learning model and perform an operation, but may perform an operation by transmitting sensor information to an external device, such as the AI server 200, and receiving results generated in response thereto.

AI+Robot+Self-Driving to which the Disclosure can be Applied

An AI technology and a self-driving technology are applied to the robot 100a, and the robot 100a may be implemented as a guidance robot, a transport robot, a cleaning robot, a wearable robot, an entertainment robot, a pet robot, an unmanned flight robot, etc.

The robot 100a to which the AI technology and the self-driving technology have been applied may mean a robot itself having a self-driving function or may mean the robot 100a interacting with the self-driving vehicle 100b.

The robot 100a having the self-driving function may collectively refer to devices that autonomously move along a given flow without control of a user or autonomously determine a flow and move.

The robot 100a and the self-driving vehicle 100b having the self-driving function may use a common sensing method in order to determine one or more of a moving path or a running plan. For example, the robot 100a and the self-driving vehicle 100b having the self-driving function may determine one or more of a moving path or a running plan using information sensed through LIDAR, a radar, a camera, etc.

The robot 100a interacting with the self-driving vehicle 100b is present separately from the self-driving vehicle 100b, and may perform an operation associated with a self-driving function inside or outside the self-driving vehicle 100b or associated with a user got in the self-driving vehicle 100b.

In this case, the robot 100a interacting with the self-driving vehicle 100b may control or assist the self-driving function of the self-driving vehicle 100b by obtaining sensor information in place of the self-driving vehicle 100b and providing the sensor information to the self-driving vehicle 100b, or by obtaining sensor information, generating surrounding environment information or object information, and providing the surrounding environment information or object information to the self-driving vehicle 100b.

Alternatively, the robot 100a interacting with the self-driving vehicle 100b may control the function of the self-driving vehicle 100b by monitoring a user got in the self-driving vehicle 100b or through an interaction with a user. For example, if a driver is determined to be a drowsiness state, the robot 100a may activate the self-driving function of the self-driving vehicle 100b or assist control of the driving unit of the self-driving vehicle 100b. In this case, the function of the self-driving vehicle 100b controlled by the robot 100a may include a function provided by a navigation system or audio system provided within the self-driving vehicle 100b, in addition to a self-driving function simply.

Alternatively, the robot 100a interacting with the self-driving vehicle 100b may provide information to the self-driving vehicle 100b or may assist a function outside the self-driving vehicle 100b. For example, the robot 100a may provide the self-driving vehicle 100b with traffic information, including signal information, as in a smart traffic light, and may automatically connect an electric charger to a filling inlet through an interaction with the self-driving vehicle 100b as in the automatic electric charger of an electric vehicle.

AI+Robot+XR to which the Disclosure can be Applied

An AI technology and an XR technology are applied to the robot 100a, and the robot 100a may be implemented as a guidance robot, a transport robot, a cleaning robot, a wearable robot, an entertainment robot, a pet robot, an unmanned flight robot, a drone, etc.

The robot 100a to which the XR technology has been applied may mean a robot, that is, a target of control/interaction within an XR image. In this case, the robot 100a is different from the XR device 100c, and they may operate in conjunction with each other.

When the robot 100a, that is, a target of control/interaction within an XR image, obtains sensor information from sensors including a camera, the robot 100a or the XR device 100c may generate an XR image based on the sensor information, and the XR device 100c may output the generated XR image. Furthermore, the robot 100a may operate based on a control signal received through the XR device 100c or a user's interaction.

For example, a user may identify a corresponding XR image at timing of the robot 100a, remotely operating in conjunction through an external device, such as the XR device 100c, may adjust the self-driving path of the robot 100a through an interaction, may control an operation or driving, or may identify information of a surrounding object.

AI+Self-Driving+XR to which the Disclosure can be Applied

An AI technology and an XR technology are applied to the self-driving vehicle 100b, and the self-driving vehicle 100b may be implemented as a movable type robot, a vehicle, an unmanned flight body, etc.

The self-driving vehicle 100b to which the XR technology has been applied may mean a self-driving vehicle equipped with means for providing an XR image or a self-driving vehicle, that is, a target of control/interaction within an XR image. Particularly, the self-driving vehicle 100b, that is, a target of control/interaction within an XR image, is different from the XR device 100c, and they may operate in conjunction with each other.

The self-driving vehicle 100b equipped with the means for providing an XR image may obtain sensor information from sensors including a camera, and may output an XR image generated based on the obtained sensor information. For example, the self-driving vehicle 100b includes an HUD, and may provide a passenger with an XR object corresponding to a real object or an object within a screen by outputting an XR image.

In this case, when the XR object is output to the HUD, at least some of the XR object may be output with it overlapping a real object toward which a passenger's view is directed. In contrast, when the XR object is displayed on a display included within the self-driving vehicle 100b, at least some of the XR object may be output so that it overlaps an object within a screen. For example, the self-driving vehicle 100b may output XR objects corresponding to objects, such as a carriageway, another vehicle, a traffic light, a signpost, a two-wheeled vehicle, a pedestrian, and a building.

When the self-driving vehicle 100b, that is, a target of control/interaction within an XR image, obtains sensor information from sensors including a camera, the self-driving vehicle 100b or the XR device 100c may generate an XR image based on the sensor information. The XR device 100c may output the generated XR image. Furthermore, the self-driving vehicle 100b may operate based on a control signal received through an external device, such as the XR device 100c, or a user's interaction.

### DEFINITION OF TERMS

eLTE eNB: An eLTE eNB is an evolution of an eNB that supports connectivity to EPC and NGC.

gNB: A node which supports the NR as well as connectivity to NGC.

New RAN: A radio access network which supports either NR or E-UTRA or interfaces with the NGC.

Network slice: A network slice is a network defined by the operator customized to provide an optimized solution for a specific market scenario which demands specific requirements with end-to-end scope.

Network function: A network function is a logical node within a network infrastructure that has well-defined external interfaces and well-defined functional behavior.

NG-C: A control plane interface used on NG2 reference points between new RAN and NGC.

NG-U: A user plane interface used on NG3 reference points between new RAN and NGC.

Non-standalone NR: A deployment configuration where the gNB requires an LTE eNB as an anchor for control plane connectivity to EPC, or requires an eLTE eNB as an anchor for control plane connectivity to NGC.

Non-standalone E-UTRA: A deployment configuration where the eLTE eNB requires a gNB as an anchor for control plane connectivity to NGC.

User plane gateway: A termination point of NG-U interface.

System General

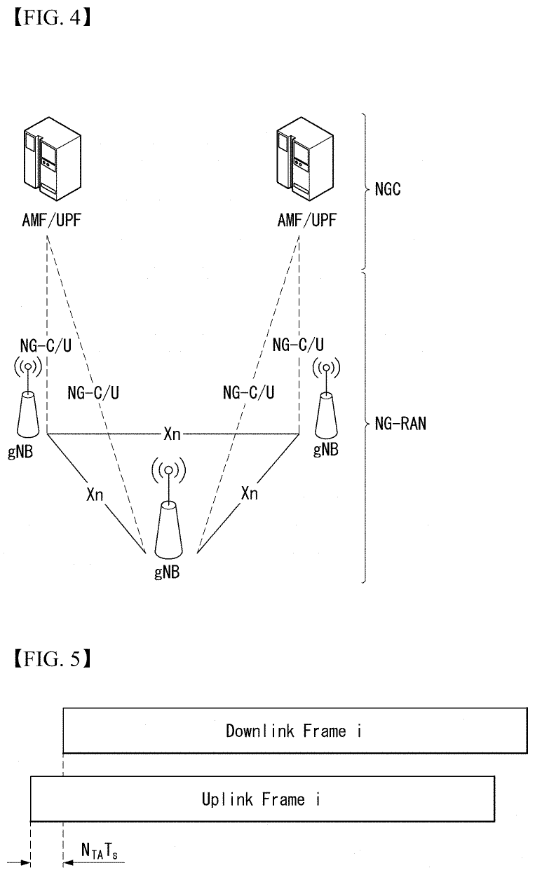

FIG. 4 illustrates an example of an overall structure of a new radio (NR) system to which a method proposed by the present specification is applicable.

Referring to FIG. 4, an NG-RAN consists of gNBs that provide an NG-RA user plane (new AS sublayer/PDCP/RLC/MAC/PHY) and control plane (RRC) protocol terminations for a user equipment (UE).

The gNBs are interconnected with each other by means of an Xn interface.

The gNBs are also connected to an NGC by means of an NG interface.

More specifically, the gNBs are connected to an access and mobility management function (AMF) by means of an N2 interface and to a user plane function (UPF) by means of an N3 interface.

New Rat (NR) Numerology and Frame Structure

In the NR system, multiple numerologies may be supported. The numerologies may be defined by subcarrier spacing and a cyclic prefix (CP) overhead. Spacing between the plurality of subcarriers may be derived by scaling basic subcarrier spacing into an integer N (or μ). In addition, although a very low subcarrier spacing is assumed not to be used at a very high subcarrier frequency, a numerology to be used may be selected independent of a frequency band.

In addition, in the NR system, a variety of frame structures according to the multiple numerologies may be supported.

Hereinafter, an orthogonal frequency division multiplexing (OFDM) numerology and a frame structure, which may be considered in the NR system, will be described.

A plurality of OFDM numerologies supported in the NR system may be defined as in Table 1.

TABLE 1

| μ | Δƒ = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |

Regarding a frame structure in the NR system, a size of various fields in the time domain is expressed as a multiple of a time unit of Tₛ=1/(Δfₘₐₓ·N_{f}), where Δfₘₐₓ=480·10³, and N_{f}=4096. Downlink and uplink transmissions are organized into radio frames with a duration of T_{f}=(ΔfₘₐₓN_{f}/100)·Tₛ=10 ms. The radio frame consists of ten subframes each having a section of T_{sf}=(ΔfₘₐₓN_{f}/1000)·Tₛ=1 ms. In this case, there may be a set of frames in the uplink and a set of frames in the downlink.

FIG. 5 illustrates a relation between a UL frame and a DL frame in a wireless communication system to which a method proposed by the disclosure is applicable.

As illustrated in FIG. 5, a UL frame number i for transmission from a user equipment (UE) shall start T_{TA}=N_{TA}Tₛ before the start of a corresponding downlink frame at the corresponding UE.

Regarding the numerology μ, slots are numbered in increasing order of nₛ^{μ}∈{0, . . . , N_{subframe}^{slots,μ}−1} within a subframe, and are numbered in increasing order of n_{s,f}^{μ}∈{0, . . . , N_{frame}^{slots,μ}−1} within a radio frame. One slot consists of consecutive OFDM symbols of N_{symb}^{μ} and N_{symb}^{μ} is determined depending on a numerology in use and slot configuration. The start of slots nₛ^{μ} in a subframe is aligned in time with the start of OFDM symbols nₛ^{μ}N_{symb}^{μ} in the same subframe.

Not all UEs are able to transmit and receive at the same time, and this means that not all OFDM symbols in a DL slot or an UL slot are available to be used.

Table 2 represents the number of OFDM symbols N_{symb}^{slot} per slot in a normal CP, the number of slot Nₛₗₒₜ^{frame,μ} per radio frame and the number of slot Nₛₗₒₜ^{subframe,μ} per subframe, and Table 3 represents the number of OFDM symbols in an extended CP, the number of slot per radio frame and the number of slot per subframe.

TABLE 2

| | Slot configuration | | | | | |
|---|---|---|---|---|---|---|
| | 0 | | | 1 | | |
| μ | N_{symb}^{μ} | N_{frame}^{slots,μ} | N_{subframe}^{slots,μ} | N_{symb}^{μ} | N_{frame}^{slots,μ} | N_{subframe}^{slots,μ} |
| 0 | 14 | 10 | 1 | 7 | 20 | 2 |
| 1 | 14 | 20 | 2 | 7 | 40 | 4 |
| 2 | 14 | 40 | 4 | 7 | 80 | 8 |
| 3 | 14 | 80 | 8 | — | — | — |
| 4 | 14 | 160 | 16 | — | — | — |
| 5 | 14 | 2220 | 32 | — | — | — |

TABLE 3

| | Slot configuration | | | | | |
|---|---|---|---|---|---|---|
| | 0 | | | 1 | | |
| μ | N_{symb}^{μ} | N_{frame}^{slots,μ} | N_{subframe}^{slots,μ} | N_{symb}^{μ} | N_{frame}^{slots,μ} | N_{subframe}^{slots,μ} |
| 0 | 12 | 10 | 1 | 6 | 20 | 2 |
| 1 | 12 | 20 | 2 | 6 | 40 | 4 |
| 2 | 12 | 40 | 4 | 6 | 80 | 8 |
| 3 | 12 | 80 | 8 | — | — | — |
| 4 | 12 | 160 | 16 | — | — | — |
| 5 | 12 | 2220 | 32 | — | — | — |

NR Physical Resource

Regarding physical resources in the NR system, an antenna port, a resource grid, a resource element, a resource block, a carrier part, etc. may be considered.

Hereinafter, the above physical resources possible to be considered in the NR system will be described in more detail.

First, regarding an antenna port, the antenna port is defined such that a channel over which a symbol on one antenna port is transmitted can be inferred from another channel over which a symbol on the same antenna port is transmitted. When large-scale properties of a channel received over which a symbol on one antenna port can be inferred from another channel over which a symbol on another antenna port is transmitted, the two antenna ports may be in a QC/QCL (quasi co-located or quasi co-location) relationship. Herein, the large-scale properties may include at least one of delay spread, Doppler spread, Doppler shift, average gain, and average delay.

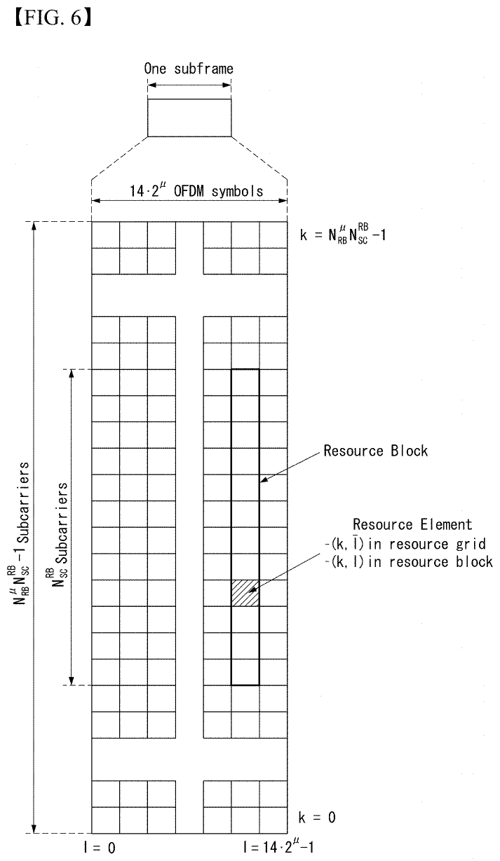

FIG. 6 illustrates an example of a resource grid supported in a wireless communication system to which a method proposed by the disclosure may be applied.

Referring to FIG. 6, a resource grid is composed of N_{RB}^{μ}N_{sc}^{RB} subcarriers in a frequency domain, each subframe composed of 14·2μ OFDM symbols, but the disclosure is not limited thereto.

In the NR system, a transmitted signal is described by one or more resource grids, composed of N_{RB}^{μ}N_{sc}^{RB} subcarriers, and 2^{μ}N_{symb}^{(μ)} OFDM symbols Herein, N_{RB}^{μ}≤N_{RB}^{max,μ}. The above N_{RB}^{max,μ} indicates the maximum transmission bandwidth, and it may change not just between numerologies, but between UL and DL.

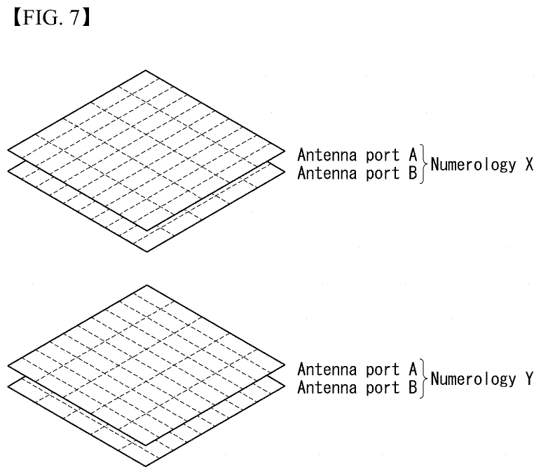

In this case, as illustrated in FIG. 7, one resource grid may be configured for the numerology μ and an antenna port p.

FIG. 7 illustrates examples of a resource grid per antenna port and numerology to which a method proposed by the present specification is applicable.

Each element of the resource grid for the numerology μ and the antenna port p is indicated as a resource element, and may be uniquely identified by an index pair (k,l̅) Herein, k=0, . . . , N_{RB}^{μ}N_{sc}^{RB}−1 is an index in the frequency domain, and l̅=0, . . . , 2^{μ}N_{symb}^{(μ)}−1 indicates a location of a symbol in a subframe. To indicate a resource element in a slot, the index pair (k,Ī) is used. Herein, l=0, . . . , N_{symb}^{μ}−1.

The resource element (k,l̅) for the numerology μ and the antenna port p corresponds to a complex value a_{k,j}^{(p,μ)}. When there is no risk of confusion or when a specific antenna port or numerology is specified, the indexes p and μ may be dropped and thereby the complex value may become a_{k,j}^{(p)} or a_{k,j}.

In addition, a physical resource block is defined as N_{sc}^{RB}=12 continuous subcarriers in the frequency domain. In the frequency domain, physical resource blocks may be numbered from 0 to N_{RB}^{μ}−1. At this point, a relationship between the physical resource block number n_{PRB} and the resource elements (k,l) may be given as in Equation 1.

$${n}_{PRB} = ⌊ \frac{k}{{N}_{sc}^{RB}} ⌋ \qquad [ Equation 1 ]$$

In addition, regarding a carrier part, a UE may be configured to receive or transmit the carrier part using only a subset of a resource grid. At this point, a set of resource blocks which the UE is configured to receive or transmit are numbered from 0 to N_{URB}^{μ}−1 in the frequency region.

Uplink Control Channel

Physical uplink control signaling should be able to carry at least hybrid-ARQ acknowledgements, CSI reports (possibly including beamforming information), and scheduling requests.

At least two transmission methods are supported for an UL control channel supported in an NR system.

The UL control channel can be transmitted in short duration around last transmitted UL symbol(s) of a slot. In this case, the UL control channel is time-division-multiplexed and/or frequency-division-multiplexed with an UL data channel within a slot. For the UL control channel in short duration, transmission over one symbol duration of a slot is supported.

Short uplink control information (UCI) and data are frequency-division-multiplexed both within a UE and between UEs, at least for the case where physical resource blocks (PRBs) for short UCI and data do not overlap.

In order to support time division multiplexing (TDM) of a short PUCCH from different UEs in the same slot, a mechanism is supported to inform the UE of whether or not symbol(s) in a slot to transmit the short PUCCH is supported at least above 6 GHz.

At least following is supported for the PUCCH in 1-symbol duration: 1) UCI and a reference signal (RS) are multiplexed in a given OFDM symbol in a frequency division multiplexing (FDM) manner if the RS is multiplexed, and 2) there is the same subcarrier spacing between downlink (DL)/uplink (UL) data and PUCCH in short-duration in the same slot.

At least a PUCCH in short-duration spanning 2-symbol duration of a slot is supported. In this instance, there is the same subcarrier spacing between DL/UL data and the PUCCH in short-duration in the same slot.

At least semi-static configuration, in which a PUCCH resource of a given UE within a slot. i.e., short PUCCHs of different UEs can be time-division multiplexed within a given duration in a slot, is supported.

The PUCCH resource includes a time domain, a frequency domain, and when applicable, a code domain.

The PUCCH in short-duration can span until an end of a slot from UE perspective. In this instance, no explicit gap symbol is necessary after the PUCCH in short-duration.

For a slot (i.e., DL-centric slot) having a short UL part, ‘short UCI’ and data can be frequency-division multiplexed by one UE if data is scheduled on the short UL part.

The UL control channel can be transmitted in long duration over multiple UL symbols so as to improve coverage. In this case, the UL control channel is frequency-division-multiplexed with the UL data channel within a slot.

UCI carried by a long duration UL control channel at least with a low peak to average power ratio (PAPR) design can be transmitted in one slot or multiple slots.

Transmission across multiple slots is allowed for a total duration (e.g. 1 ms) for at least some cases.

In the case of the long duration UL control channel, the TDM between the RS and the UCI is supported for DFT-S-OFDM.

A long UL part of a slot can be used for transmission of PUCCH in long-duration. That is, the PUCCH in long-duration is supported for both a UL-only slot and a slot having the variable number of symbols comprised of a minimum of 4 symbols.

For at least 1 or 2 UCI bits, the UCI can be repeated within N slots (N>1), and the N slots may be adjacent or may not be adjacent in slots where PUCCH in long-duration is allowed.

Simultaneous transmission of PUSCH and PUCCH for at least the long PUCCH is supported. That is, uplink control on PUCCH resources is transmitted even in the case of the presence of data. In addition to the simultaneous PUCCH-PUSCH transmission, UCI on the PUSCH is supported.

Intra-TTI slot frequency-hopping is supported.

DFT-s-OFDM waveform is supported.

Transmit antenna diversity is supported.

Both TDM and FDM between short duration PUCCH and long duration PUCCH are supported at least for different UEs in one slot. In a frequency domain, a PRB (or multiple PRBs) is a minimum resource unit size for the UL control channel. If hopping is used, a frequency resource and the hopping may not spread over a carrier bandwidth. Further, a UE-specific RS is used for NR-PUCCH transmission. A set of PUCCH resources is configured by higher layer signaling, and a PUCCH resource within the configured set is indicated by downlink control information (DCI).

As part of the DCI, it should be possible to dynamically indicate (at least in combination with RRC) the timing between data reception and hybrid-ARQ acknowledgement transmission. A combination of the semi-static configuration and (for at least some types of UCI information) dynamic signaling is used to determine the PUCCH resource for both ‘long and short PUCCH formats’. Here, the PUCCH resource includes a time domain, a frequency domain, and when applicable, a code domain. The UCI on the PUSCH, i.e., using some of the scheduled resources for the UCI is supported in case of simultaneous transmission of UCI and data.

At least UL transmission of at least single HARQ-ACK bit is supported. A mechanism enabling the frequency diversity is supported. In case of ultra-reliable and low-latency communication (URLLC), a time interval between scheduling request (SR) resources configured for a UE can be less than a slot.

Beam Management

In NR, beam management is defined as follows.

Beam management: includes at least the following description as a set of L1/L2 procedures for obtaining and maintaining a set of TRP(s) and/or UE beams that may be used for DL and UL transmission and reception:

Beam determination: an operation in which the TRP(s) or the UE selects a transmitting/receiving beam thereof.

Beam measurement: an operation in which the TRP(s) or the UE measures characteristics of a received beamforming signal.

Beam reporting: an operation in which the UE reports information of a beamformed signal based on beam measurement.

Beam sweeping: an operation that covers a spatial region using a beam transmitted and/or received during a time interval in a predetermined manner.

Further, Tx/Rx beam correspondence in the TRP and UE is defined as follows.

When at least one of the following conditions is satisfied, Tx/Rx beam correspondence in the TRP is maintained.

The TRP may determine a TRP reception beam for uplink reception based on downlink measurement of the UE for one or more transmission beams thereof.

The TRP may determine a TRP Tx beam for downlink transmission based on uplink measurement thereof for one or more Rx beams thereof.

When at least one of the following conditions is satisfied, Tx/Rx beam correspondence at the UE is maintained.

The UE may determine a UE Tx beam for uplink transmission based on downlink measurement thereof for one or more Rx beams thereof.

The UE may determine a UE reception beam for downlink reception based on an indication of TRP based on uplink measurement of one or more Tx beams.

A capability indication of UE beam correspondence related information is supported with TRP.

The following DL L1/L2 beam management procedures are supported within one or more TRPs.

P-1: P-1 is used for enabling UE measurement of different TRP Tx beams in order to support selection of TRP Tx beam/UE Rx beam(s).

Beamforming in TRP generally includes intra/inter-TRP Tx beam sweep in different beam sets. For beamforming at the UE, beamforming generally includes UE Rx beam sweep from a set of different beams.

P-2: UE measurement for different TRP Tx beams are used for changing inter/intra-TRP Tx beam(s).

P-3: When the UE uses beamforming, UE measurement of the same TRP Tx beam is used for changing a UE Rx beam

Aperiodic reporting triggered by at least the network is supported in P-1, P-2, and P-3 related operations.

UE measurement based on RS for beam management (at least CSI-RS) is configured with K (total number of beams) beams, and the UE reports measurement results of the selected N number of Tx beams. Here, N is not necessarily a fixed number. Procedures based on RS for mobility purposes are not excluded. When at least N<K, reporting information includes information representing a measurement quantity of the N number of beam(s) and the N number of DL transmission beams. In particular, for K′>1 non-zero-power (NZP) CSI-RS resources, the UE may report a CSI-RS resource indicator (CRI) of N′.

The UE may be set with the following higher layer parameters for beam management.

N≥1 reporting setting, M≥1 resource setting

Links between reporting setting and resource setting are set in agreed CSI measurement setting.

CSI-RS-based P-1 and P-2 are supported with resource and reporting settings.

P-3 may be supported regardless of presence or absence of reporting setting.

Reporting setting including at least the following contents:

Information representing the selected beam

L1 measurement reporting

Time domain operations (e.g., aperiodic operation, periodic operation, semi-persistent operation)

Frequency granularity when several frequency granularity is supported

Resource setting including at least the following contents:

Time domain operation (e.g., aperiodic operation, periodic operation, semi-persistent operation)

RS type: at least NZP CSI-RS

At least one CSI-RS resource set. Each CSI-RS resource set includes K>1 CSI-RS resources (some parameters of the K number of CSI-RS resources may be the same. For example, port number, time domain operation, density and period)

Further, NR supports the following beam reporting in consideration of L group of L>1.

Information representing a minimal group

Measurement quantity of N1 beam (L1 RSRP and CSI reporting support (when CSI-RS is for CSI acquisition)

If applicable, information representing the N1 number of DL transmission beams

The above-described group-based beam reporting may be configured in UE units. Further, the group-based beam reporting may be turned off in UE units (e.g., when L=1 or N1=1).

NR supports that the UE may trigger a mechanism that recovers from beam failure.

A beam failure event occurs when a quality of a beam pair link of a related control channel is sufficiently low (e.g., comparison with a threshold value, timeout of a related timer). A mechanism that recovers from a beam failure (or fault) is triggered when a beam fault occurs.

The network is explicitly configured in the UE having resources for transmitting UL signals for a recovery purpose. A configuration of resources is supported at a location in which the BS listens from all or some directions (e.g., random access region).

An UL transmission/resource reporting the beam fault may be located at the same time instance as that of a PRACH (resource orthogonal to a PRACH resource) or may be located at a time instance (may be configured for UE) different from that of the PRACH. Transmission of the DL signal is supported so that the UE may monitor a beam to identify new potential beams.

NR supports beam management regardless of a beam-related indication. When a beam-related indication is provided, information about a UE side beamforming/receiving procedure used for CSI-RS based measurement may be indicated to the UE through QCL. As QCL parameters to be supported in the NR, parameters for delay, Doppler, average gain, etc., used in an LTE system as well as spatial parameters for beamforming at a receiving terminal will be added, and QCL parameters to be supported in the NR may include an angle of arrival related parameters in terms of UE receiving beamforming and/or an angle of departure related parameters in terms of BS receiving beamforming. The NR supports use of the same or different beams in the control channel and the corresponding data channel transmission.

For NR-PDCCH transmission supporting robustness of beam pair link blocking, the UE may be configured to simultaneously monitor an NR-PDCCH on the M number of beam pair links. Here, M>1 and a maximum value of M may depend on at least a UE capability.

The UE may be configured to monitor an NR-PDCCH on different beam pair link(s) in different NR-PDCCH OFDM symbols. Parameters related to UE Rx beam setting for monitoring the NR-PDCCH on multiple beam pair links are configured by higher layer signaling or MAC CE and/or are considered in a search space design.

At least NR supports an indication of a spatial QCL hypothesis between a DL RS antenna port(s) and a DL RS antenna port(s) for demodulation of a DL control channel. A candidate signaling method for a beam indication of the NR-PDCCH (i.e., configuration method of monitoring the NR-PDCCH) is a combination of MAC CE signaling, RRC signaling, DCI signaling, specification transparent, and/or an implicit method, and signaling methods thereof.

For reception of a unicast DL data channel, the NR supports an indication of a spatial QCL hypothesis between the DL RS antenna port and the DMRS antenna port of the DL data channel.

Information representing the RS antenna port is displayed through DCI (downlink grant). Further, the information represents the DMRS antenna port and the RS antenna port being QCL. A different set of the DMRS antenna port of the DL data channel may be represented as a different set of the RS antenna port and QCL.

Hybrid Beamforming

Existing beamforming technology using multiple antennas may be classified into an analog beamforming scheme and a digital beamforming scheme according to a location to which beamforming weight vector/precoding vector is applied.

The analog beamforming scheme is a beamforming technique applied to an initial multi-antenna structure. The analog beamforming scheme may mean a beamforming technique which branches analog signals subjected to digital signal processing into multiple paths and then applies phase-shift (PS) and power-amplifier (PA) configurations for each path.

For analog beamforming, a structure in which an analog signal derived from a single digital signal is processed by the PA and the PS connected to each antenna is required. In other words, in an analog stage, a complex weight is processed by the PA and the PS.

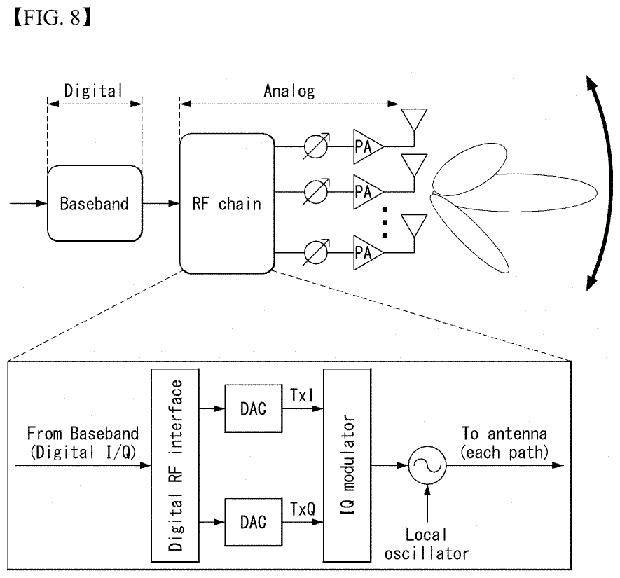

FIG. 8 illustrates an example of a block diagram of a transmitter consisting of an analog beamformer and an RF chain. FIG. 8 is merely for convenience of explanation and does not limit the scope of the disclosure.

In FIG. 8, the RF chain means a processing block for converting a baseband (BB) signal into an analog signal. The analog beamforming scheme determines beam accuracy according to characteristics of elements of the PA and PS and may be suitable for narrowband transmission due to control characteristics of the elements.

Further, since the analog beamforming scheme is configured with a hardware structure in which it is difficult to implement multi-stream transmission, a multiplexing gain for transfer rate enhancement is relatively small. In addition, in this case, beamforming per UE based on orthogonal resource allocation may not be easy.

On the contrary, in the case of digital beamforming scheme, beamforming is performed in a digital stage using a baseband (BB) process in order to maximize diversity and multiplexing gain in a MIMO environment.

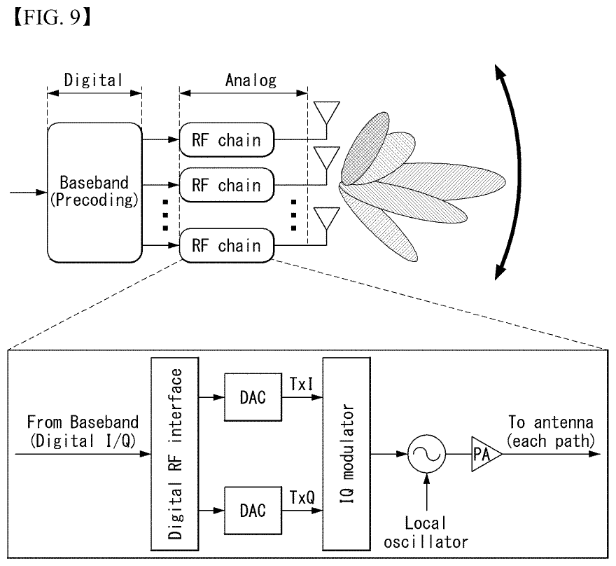

FIG. 9 illustrates an example of a block diagram of a transmitter consisting of a digital beamformer and an RF chain. FIG. 9 is merely for convenience of explanation and does not limit the scope of the disclosure.

In FIG. 9, beamforming can be performed as precoding is performed in a BB process. Here, the RF chain includes a PA. This is because a complex weight derived for beamforming is directly applied to transmission data in the case of digital beamforming scheme.

Furthermore, since different beamforming can be performed per UE, it is possible to simultaneously support multi-user beamforming. Besides, since independent beamforming can be performed per UE to which orthogonal resources are assigned, scheduling flexibility can be improved and thus a transmitter operation suitable for the system purpose can be performed. In addition, if a technology such as MIMO-OFDM is applied in an environment supporting wideband transmission, independent beamforming can be performed per subcarrier.

Accordingly, the digital beamforming scheme can maximize a maximum transfer rate of a single UE (or user) based on system capacity enhancement and enhanced beam gain. On the basis of the above-described properties, digital beamforming based MIMO scheme has been introduced to existing 3G/4G (e.g., LTE(-A)) system.

In the NR system, a massive MIMO environment in which the number of transmit/receive antennas greatly increases may be considered. In cellular communication, a maximum number of transmit/receive antennas applied to an MIMO environment is generally assumed to be 8. However, as the massive MIMO environment is considered, the number of transmit/receive antennas may increase to tens or hundreds or more.

If the aforementioned digital beamforming scheme is applied in the massive MIMO environment, a transmitter has to perform signal processing on hundreds of antennas through a BB process for digital signal processing. Hence, signal processing complexity may significantly increase, and complexity of hardware implementation may remarkably increase because as many RF chains as the number of antennas are required.

Furthermore, the transmitter needs independent channel estimation for all the antennas. In addition, in case of an FDD system, since the transmitter requires feedback information about a massive MIMO channel composed of all antennas, pilot and/or feedback overhead may considerably increase.

On the other hand, when the aforementioned analog beamforming scheme is applied in the massive MIMO environment, hardware complexity of the transmitter is relatively low.

However, an increase degree of a performance using multiple antennas is very low, and flexibility of resource allocation may decrease. In particular, it is difficult to control the beam per frequency in the wideband transmission.

Accordingly, instead of exclusively selecting only one of the analog beamforming scheme and the digital beamforming scheme in the massive MIMO environment, there is a need for a hybrid transmitter configuration scheme in which an analog beamforming structure and a digital beamforming structure are combined.

Analog Beam Scanning

In general, analog beamforming may be used in a pure analog beamforming transmitter/receiver and a hybrid beamforming transmitter/receiver. In this instance, analog beam scanning can perform estimation for one beam at the same time. Thus, a beam training time required for the beam scanning is proportional to the total number of candidate beams.

As described above, the analog beamforming necessarily requires a beam scanning process in a time domain for beam estimation of the transmitter/receiver. In this instance, an estimation time Ts for all of transmit and receive beams may be represented by the following Equation 2.

Tₛ=tₛ×(K_{T}×K_{R}) [symbol] Equation 2

[symbol]

In Equation 2, tₛ denotes time required to scan one beam, K_{T} denotes the number of transmit beams, and K_{R} denotes the number of receive beams.

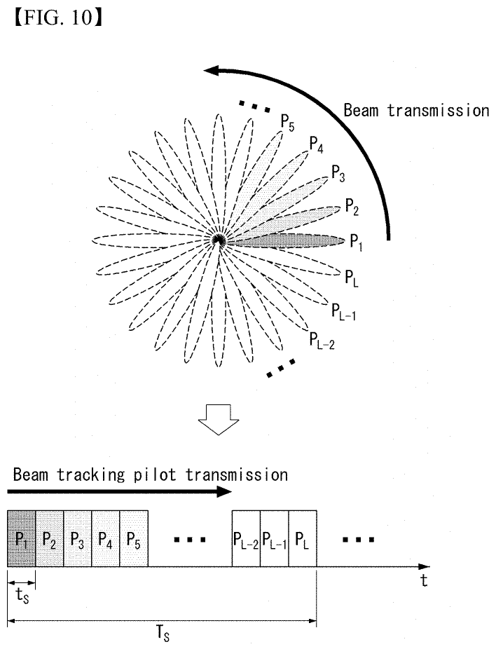

FIG. 10 illustrates an example of an analog beam scanning scheme.

In FIG. 10, it is assumed that the total number K_{T} of transmit beams is L, and the total number K_{R} of receive beams is 1. In this case, since the total number of candidate beams is L, L time intervals are required in the time domain.

In other words, since only the estimation of one beam can be performed in a single time interval for analog beam estimation, L time intervals are required to estimate all of L beams Pi to PL as shown in FIG. 10. The UE feeds back, to the base station, an identifier (ID) of a beam with a highest signal strength after an analog beam estimation procedure is ended. That is, as the number of individual beams increases according to an increase in the number of transmit/receive antennas, a longer training time may be required.

Because the analog beamforming changes a magnitude and a phase angle of a continuous waveform of the time domain after a digital-to-analog converter (DAC), a training interval for an individual beam needs to be secured for the analog beamforming, unlike the digital beamforming. Thus, as a length of the training interval increases, efficiency of the system may decrease (i.e., a loss of the system may increase).

Beam Failure Detection and Beam Failure Recovery Procedure

In a beamforming system, radio link failure (RLF) may often occur due to rotation, movement or beam blocking of the UE.

Thus, to prevent frequent occurrences of RLF, radio link failure recovery (RFR) is supported in NR.

The BFR may be similar to a radio link failure recovery procedure, and the BFR is supported when the UE knows a new candidate beam(s).

For a better understanding, (1) radio link monitoring and (2) link recovery procedures are described below.

Radio Link Monitoring

The DL radio link quality of the primary cell is monitored by the UE, indicating an in-sync or out-of-sync state to a higher layer.

The term “cell” as used herein may be a component carrier, a carrier, or a BW.

The UE does not require DL radio link quality in DL BWPs other than the active DL BWP of the primary cell.

The UE may be configured for each DL BWP of SpCell with a set of resource indexes. The set of resource indexes corresponds to the higher layer parameter RadioLinkMonitoringRS for radio link monitoring by the higher layer parameter failureDetectionResources.

RadioLinkMonitoringRS, which is a higher layer parameter having a CSI-RS resource configuration index (csi-RS-index) or an SS/PBCH block index (ssb-index), is provided to the UE.

When RadioLinkMonitoringRS is not provided to the UE, the TCI state for the PDCCH including one or more RSs including one or more from the CSI-RS and/or SS/PBCH block is provided to the UE.
When the active TCI state for the PDCCH contains a single RS, the UE uses the RS provided for the active TCI state for the PDCCH for radio link monitoring.
When the active TCI state for the PDCCH includes two RSs, the UE is not expected to have QCL-TypeD in one RS and uses one RS for radio link monitoring. Here, the UE does not expect both the RSs to have QCL-TypeD.
The UE does not use aperiodic RS for radio link monitoring.

Table 4 below is an example of RadioLinkMonitoringConfig IE.

The RadioLinkMonitoringConfig IE is used to configure radio link monitoring for detecting beam failure and/or cell radio link failure.

```
TABLE 4
ASN1START
TAG-RADIOLINKMONITORINGCONFIG-START
RadioLinkMonitoringConfig ::= SEQUENCE {
failureDetectionResourcesToAddModList SEQUENCE
(SIZE(1..maxNrofFailureDetectionResources)) OF RadioLinkMonitoringRS
  OPTIONAL, -- Need N
failureDetectionResourcesToReleaseList SEQUENCE
(SIZE(1..maxNrofFailureDetectionResources)) OF RadioLinkMonitoringRS-Id
  OPTIONAL,-- Need N
beamFailureInstanceMaxCount ENUMERATED {n1, n2, n3, n4, n5, n6, n8, n10}
  OPTIONAL, -- Need S
beamFailureDetectionTimer ENUMERATED {pbfd1, pbfd2, pbfd3, pbfd4, pbfd5, pbfd6, pbfd8, pbfd10}
  OPTIONAL, -- Need R
...
}
RadioLinkMonitoringRS ::= SEQUENCE {
radioLinkMonitoringRS-Id RadioLinkMonitoringRS-Id,
purpose ENUMERATED
{beamFailure, rlf, both},
detectionResource CHOICE {
ssb-Index SSB-Index,
csi-RS-Index NZP-CSI-RS-ResourceId
},
...
}
TAG-RADIOLINKMONITORINGCONFIG-STOP
-- ASN1STOP
```

In Table 4, the parameter beamFailureDetectionTimer is a timer for detecting beam failure. The beamFailureDetectionTimer parameter indicates how many beam failure events the UE triggers beam failure recovery after.

n1 corresponds to one beam failure instance, and n2 corresponds to two beam failure instances. When the network reconfigures the corresponding field, the UE resets the counter related to the ongoing beam FailureDetectionTimer and beamFailureInstanceMaxCount.

If there is no corresponding field, the UE does not trigger beam failure recovery.

Table 5 below is an example of BeamFailureRecoveryConfig IE.

For beam failure detection, the BeamFailureRecoveryConfig IE is used to configure RACH resources and candidate beams for beam failure recovery in the UE.

```
TABLE 5
ASN1START
TAG-BEAM-FAILURE-RECOVERY-CONFIG-START
BeamFailureRecoveryConfig ::= SEQUENCE {
rootSequenceIndex-BFR INTEGER (0..137)
  OPTIONAL, -- Need M
rach-ConfigBFR RACH-ConfigGeneric
  OPTIONAL, -- Need M
rsrp-ThresholdSSB RSRP-Range
  OPTIONAL, -- Need M
candidateBeamRSList SEQUENCE
(SIZE(1..maxNrofCandidateBeams)) OF PRACH-ResourceDedicatedBFR
  OPTIONAL, -- Need M
ssb-perRACH-Occasion ENUMERATED {oneEighth, oneFourth, oneHalf, one, two, four, eight, sixteen}
  OPTIONAL, -- Need M
ra-ssb-OccasionMaskIndex INTEGER (0..15)
  OPTIONAL, -- Need M
recoverySearchSpaceId SearchSpaceId
  OPTIONAL, -- Cond CF-BFR
ra-Prioritization RA-Prioritization
  OPTIONAL, -- Need R
beamFailureRecoveryTimer ENUMERATED {ms10, ms20, ms40, ms60, ms80, ms100, ms150, ms200}
  OPTIONAL, --Need M
...
}
PRACH-ResourceDedicatedBFR ::= CHOICE {
ssb BFR-SSB-Resource,
csi-RS BFR-CSIRS-Resource
}
BFR-SSB-Resource ::= SEQUENCE {
ssb SSB-Index,
ra-PreambleIndex INTEGER (0..63),
...
}
BFR-CSIRS-Resource ::= SEQUENCE {
csi-RS NZP-CSI-RS-ResourceId,
ra-OccasionList SEQUENCE (SIZE(1..maxRA-
OccasionsPerCSIRS)) OF INTEGER (0..maxRA-Occasions-1) OPTIONAL, -- Need R
ra-PreambleIndex INTEGER (0..63)
  OPTIONAL, -- Need R
...
}
TAG-BEAM-FAILURE-RECOVERY-CONFIG-STOP
-- ASN1STOP
```

In Table 5, beamFailureRecoveryTimer is a parameter indicating a timer for beam failure recovery, and its value is set in ms.

candidateBeamRSList is a parameter representing a list of reference signals (CSI-RS and/or SSB) for identifying random access (RA) parameters related to a candidate beam for recovery.

RecoverySearchSpaceId refers to a search space used for a BFR random access response (RAR).

When the radio link quality is lower than the threshold Qout, this indicates that the physical layer of the UE is in an out-of-sync state for the higher layer in the radio frame where the radio link quality has been measured.

When the radio link quality is better than the threshold Qin, this indicates that the physical layer of the UE is in an in-sync state for the higher layer in the radio frame where the radio link quality has been measured.

Link Recovery Procedure

The UE provides, to the serving cell, a set q0 of periodic CSI-RS resource configuration indexes by the higher layer parameter failureDetectionResources and a set q1 of CSI-RS resource configuration indexes and/or SS/PBCH block indexes by candidateBeamRSList for measuring the radio link quality of the serving cell.

When the UE fails to receive the higher layer parameter failureDetectionResources, the UE determines the set q0 to include the periodic CSR-RS resource configuration index and the SS/PBCH block index having the same RS index in the RS set indicated by the TCI state and used for the UE to monitor the PDCCH.

When the threshold Qout_LR corresponds to each of the default value of the higher layer parameter rlmInSyncOutOfSyncThreshold and the value provided by the higher layer parameter rsrp-ThresholdSSB, the physical layer of the UE evaluates the radio link quality according to the set q0 of the resource configuration for the threshold Qout_LR.

For set q0, the UE evaluates the radio link quality according to the periodic CSI-RS resource configuration or SS/PBCH block quasi co-located with the DM-RS of the monitored PDCCH reception.

The UE applies the Qin_LR threshold to the L1-RSRP measurements obtained from the SS/PBCH block.

The UE scales each CSI-RS received power to a value provided by the higher layer parameter powerControlOffsetSS and then applies the Qin_LR threshold to the L1-RSRP measurement obtained for the CSI-RS resource.

The physical layer of the UE provides the higher layer with information about when the radio link quality for all corresponding resource configurations in the set used by the UE to evaluate the radio link quality is worse than the threshold Qout_LR.

The physical layer provides higher layers with a notification of information about when the radio link quality is worse than the threshold Qout_LR which has a periodicity determined by the maximum value of 2 msec and the shortest period of the SS/PBCH blocks in set q0 used for the UE to evaluate the radio link quality or the periodic CSI-RS configuration.

According to a request from the higher layer, the UE provides the higher layer with a corresponding L1-RSRP measurement equal to or larger than a corresponding threshold and the SS/PBCH block index and/or the periodic CSI-RS configuration index from set q1.

In order to monitor the PDCCH in the control resource set, the UE may be provided with control resources configured through a link to a search space set provided by the higher layer parameter recoverySearchSpaceId.

If the higher layer parameter recoverySearchSpaceId is provided to the UE, the UE does not expect another search space configured to monitor the PDCCH to be provided in the control resource set associated with the search space set provided by the recoverySearchSpaceId.

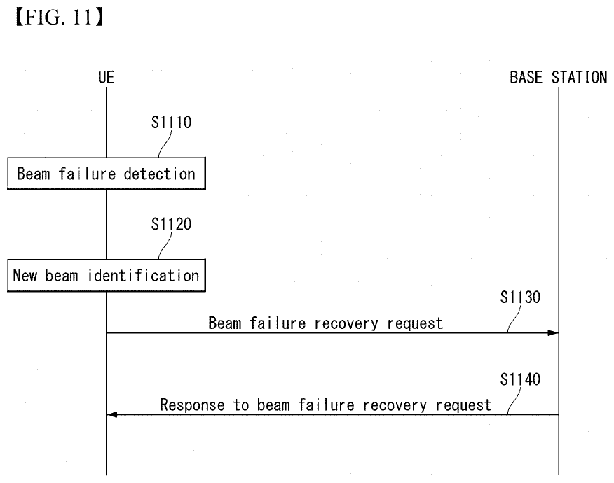

The BFD and BFR procedures are described below with reference to FIG. 11.

When a beam failure is detected in the serving SSB or CSI-RS(s), a BFR procedure used to indicate a new SSB or CSI-RS to the serving base station may be configured by RRC.

RRC configures a BeamFailureRecoveryConfig for beam failure detection and recovery procedures.

FIG. 11 is a flowchart illustrating an example beam failure recovery procedure.

Referring to FIG. 11, the beam failure recovery procedure (BFR) includes (a) a beam failure detection step (S1110), (2) a new beam identification step (S1120), a beam failure recovery request (BFRQ) step (S1130), and (4) a step for monitoring a response to the BFRQ from the base station (S1140).

Here, in step S1130, a PRACH preamble or PUCCH may be used for BFRQ transmission.

When the block error rate (BLER) of all serving beams is greater than a threshold in S1110, this is referred to as a beam failure instance.

According to an embodiment, the block error rate (BLER) may be a hypothetical block error rate. The hypothetical BLER refers to a probability that demodulation of the corresponding information fails when it is assumed that control information is transmitted through the corresponding PDCCH.

One or more search spaces for monitoring the PDCCH may be configured in the UE, and the phrase “all serving beams” (PDCCH beams) means all different beams that may be configured per search space.

The RS set q0 to be monitored by the UE may be explicitly configured by RRC or may be implicitly determined by the beam RS for the control channel.

Regarding the explicit configuration of the BFD RS set, the base station may explicitly configure the beam RS(s) for the purpose of beam failure detection, in which case the corresponding beam RS(s) correspond to the ‘all serving beams (PDCCH beams).’

Regarding the implicit configuration of the BFD RS set, a control resource set (CORESET) ID, which is a resource area in which PDCCH may be transmitted, is configured in each search space, and RS information (e.g., CSI-RS resource ID, SSB ID) QCLed in terms of spatial RX parameter may be indicated/configured for each CORESET ID. In the NR standard, the QCLed RS is indicated/configured through a transmit configuration information (TCI) indication.

The indication of the beam failure instance for the higher layer is periodic, and the indication interval is determined by the shortest periodicity of the BFD RS set.

As a result of the evaluation, if it is lower than the BLER threshold of the beam failure instance, information is not delivered to the higher layer. This is because the beam quality is in good condition.

When N preset continuous beam failure instances occur, a beam failure is declared. Here, N (natural number) is the NrofBeamFailureInstance parameter configured by RRC. One port CSI-RS and SSB are supported for the BFD RS set.

In S1120, the network (NW) may transmit a configuration of one or more PRACH resources/sequences to the UE. The PRACH sequence is mapped to at least one new candidate beam.

The UE selects a new beam from among candidate beams having L1-RSRP equal to or greater than the threshold configured by RRC and transmits the PRACH through the selected beam. In this case, the beam selected by the UE may vary according to the UE implementation method.

As a specific example, the UE may find a beam according to the following 1) to 3).

1) The UE searches for a beam having a predetermined quality value (Q_in) or more among RSs set by the base station as a candidate beam RS set.

Here, the beam quality is based on reference signal received power (RSRP). The candidate beam RS set configured by the base station is classified as follows.
All beam RSs in the RS beam set are configured of SSBs
All beam RSs in the RS beam set are configured of CSI-RS resources
All beam RSs in the RS beam set are configured of SSBs and CSI-RS resources

When one beam RS exceeds the threshold, a corresponding beam RS is selected and, when a plurality of beam RSs exceed the predetermined quality value (Q_in), any one of the corresponding beam RSs is selected. If there is no beam exceeding the predetermined quality value (Q_in), the UE searches for a beam according to 2) below.

2) The UE searches for a beam having a predetermined quality value (Q_in) or more among SSBs (connected to contention based PRACH resources). When one SSB exceeds the predetermined quality value (Q_in), a corresponding beam RS is selected, and when a plurality of SSBs exceed the predetermined quality value (Q_in), any one of the corresponding beam RSs is selected. If there is no beam exceeding the predetermined quality value (Q_in), the UE searches for a beam according to 3) below.

3) The UE selects any SSB among SSBs (connected with contention based PRACH resources).

Next, the steps (S1130 and S1140) of transmitting the BFRQ and monitoring the response to the BRFQ are performed.

Specifically, in S1130, the UE transmits a PRACH resource and preamble that are directly or indirectly connected to a preselected beam RS (CSI-RS or SSB) to the base station.

The direct connection configuration may correspond to the following two cases.

1. When a contention-free PRACH resource & preamble are configured for a specific RS in a candidate beam RS set separately set for BFR purposes

2. When (contention based) PRACH resource and preamble one-to-one mapped with the SSBs generally configured for random access or other purposes

The indirect connection configuration includes a case in which non-contention PRACH resources and preambles are not configured for a specific CSI-RS in the candidate beam RS set separately configured for BFR purposes. In this case, the UE may select a (contention-free) PRACH resource and a preamble connected to the SSB designated (i.e., quasi-co-located (QCLed) with respect to spatial Rx parameter) as receivable with the same reception beam as the corresponding CSI-RS.

In S1140, the UE transmits the PRACH and the preamble (BFRQ) and, after four slots, starts monitoring a response to the BRFQ.

A dedicated control resource set (dedicated CORESET) may be configured to monitor the duration of the window and the response to the BFRQ from the base station by RRC. The UE assumes that the dedicated CORESET has a spatial quasi co-located (spatial QCL) relationship with the DL RS of the candidate beam identified by the UE in the beam failure recovery request.

Specifically, the response to the non-contention PRACH resource and the preamble is transmitted through a PDCCH masked with C-RNTI, which is received in a search space separately RRC-configured for BFR. The search space may be configured in a specific control resource set (CORESET) (for BFR).

A response to the contention PRACH may be received by reusing the control resource set (e.g., CORESET 0 or CORESET 1) and search space configured for general contention PRACH based random access.

When the timer expires or the number of PRACH transmissions reaches a preset maximum number, the UE may stop the BFR procedure. Here, the maximum number of PRACH transmissions and the timer may be set by RRC.

According to an embodiment, when the UE does not receive a response to the BFRQ from the base station for a predetermined time, the UE may repeat S1120 to S1140.

The repetition process may be performed until PRACH transmission reaches a preset maximum number of times or until the configured timer expires. When the timer expires, the UE stops non-contention PRACH transmission, but the UE may perform contention-based PRACH transmission by SSB selection until the maximum number of times is reached.

The necessity of monitoring the pre-configured CORESET after the declaration of a beam failure is described below in detail.

It is discussed that the UE is required to perform blind detection on the PDCCH in the pre-configured CORESET (or in the search space configured therein) even after a beam failure is declared or after the time of transmission of the PRACH in the above-described beam failure recovery process.

Even if a beam failure is declared, the base station does not know the situation of the UE and, even after the UE transmits the PRACH, the base station that has not received the PRACH does not recognize that the UE is in a beam failure situation. Thus, DCI may be transmitted through the pre-configured CORESET(s).

Therefore, the UE may receive the PDCCH through a pre-configured (or used) SS/CORESET instead of the search space (SS-BFR) configured for BFR. Thus, the UE needs to keep on monitoring the pre-configured CORESET(s) (or search space(s) configured therein).

When the PDCCH is successfully received in a preconfigured SS/CORESET other than SS-BFR, the following two cases may exist.

The first case is when the existing CORESET/SS beam quality is still low, but reception of the PDCCH accidently succeeds (hereinafter, case 1), and the second case is when as time passes after the beam failure detection, the existing CORESET/SS beam quality gets better (hereinafter, case 2).

Case 1 is the case of successfully receiving the PDCCH according to a relatively short-term channel variation (e.g., small scale fading factor(s)), and case 2 is the case of successfully receiving the PDCCH according to a relatively long-term channel variation (e.g., large scale fading factor(s)).

The occurrence of case 1 is described below in detail.

Upon detecting a beam failure, the UE does not measure the BLER from the actual PDCCH DMRS but measures the hypothetical BLER as described above. That is, under the assumption that PDCCH is transmitted in the corresponding CORESET/SS, BLER estimation is performed using the reception quality of the QCLed RS spatially in the corresponding CORESET.

There may be a difference between the reception quality of the PDCCH actually transmitted from the corresponding CORESET/SS and the virtual quality. Further, since BLER means an error probability, there is also a probability of receiving the PDCCH although it is low. Therefore, even if the hypothetical BLER of a specific CORESET is less than or equal to a preset threshold, there is a possibility that the PDCCH may be successfully received instantly from the corresponding CORESET.

The occurrence of case 2 is described below in detail.

After the beam failure is detected and until it is declared, the line-of-sight ray of the corresponding CORESET is blocked by a certain object (e.g., human body), and after the time point (or after the UE transmits PRACH), the object may disappear, so that the strength of the line-of-sight ray may be sharply increased. Further, there may be a case in which the quality of the corresponding CORESET beam is improved again as the UE moves or rotates.

As discussed above, when case 2 occurs after the UE declares a beam failure, the problem with the preset CORESET is addressed, so that the beam failure recovery procedure is stopped. When case 1 occurs, the issue with the preset CORESET is not regarded as having been addressed, the beam failure recovery procedure needs to continue.

In order to continuously perform the beam failure recovery procedure adaptively according to the radio link condition as described above, the disclosure proposes the following methods.

Further, the embodiments and/or methods described in the disclosure are differentiated solely for ease of description, and some components in any one method may be replaced, or combined with components of another method.

[Method 1]

Assuming that the UE receives the PDCCH/DCI (in SS/CORESET, not SS-BFR) after the beam failure declaration, the following three beam RSs may be considered.

1) Beam RS (e.g., CSI-RS, SSB) corresponding to the previously received PDCCH/DCI,

2) At least one beam RS among all preset SS/CORESET beams

3) Beam RS explicitly indicated for beam failure detection

The UE identifies whether the quality (e.g., hypothetical BLER) for at least one beam RS among 1) to 3) above is better than a preset/specified threshold (during a predetermined time and/or a predetermined number of times) and, if better, the UE stops the beam failure recovery procedure, otherwise the UE does not stop the beam failure recovery procedure.

In method 1 above, the ‘beam RS corresponding to the previously received PDCCH/DCI’ means the spatially QCLed RS (with the PDCCH DMRS) indicated in the TCI configured for the SS/CORESET where the corresponding PDCCH has been received in the case of the indirect BFD RS configuration. In the case of direct BFD RS configuration (Explicit BFD RS configuration), it means an RS indicated for BFD purposes for the SS/CORESET in which the corresponding PDCCH has been received.

In the case of 2) or 3) above, what is meant that the PDCCH has been successfully received in a specific CORESET is to raise the probability of finding a beam by performing an identification for preconfigured other SS(s)/CORESET(s) as well as an identification of the corresponding CORESET because the quality of other CORESETs has a chance of having been improved.

Case 3) above corresponds to the case of explicit BFD RS configuration.

When the quality of the beam RS is a block error rate (BLER), “the block error rate (BLER) is excellent” means that “the value is low.”

In a specific method of ‘identifying whether it is superior to the preset/specified threshold value,’ even if the quality check process is passed only once, it may be determined as beam success. However, even if the quality is improved temporarily, it may be identified whether the quality remains excellent during a predetermined time or whether the quality is excellent a predetermined number of times so as to prevent the beam failure procedure from being stopped.

In the case of using the number of times according to an embodiment, the value for the number of beam failure instances set for the declaration of beam failure (e.g., assuming that N beam failure instances (continuously) occur, the N value is the value) may be used as it is. If the quality of the beam is less than or equal to a specific threshold for all the preset N times, it may be determined as success. Or, if the beam quality is the specific threshold or larger M times or more (M<N), it may be determined to be beam success. Here, M is a natural number, which may be set by the base station or may be a value separately set.

Stopping the beam failure recovery procedure is the same as assuming that the random access procedure for the corresponding BFR is successful by the UE.

According to an embodiment, application of method 1 may be limited only to when the PDCCH/DCI is received in the (preconfigured) SS/CORESET, not the SS-BFR, as well as when the PDCCH/DCI is received in any SS/CORESET. This is because when the PDCCH/DCI is received in SS-BFR, it may be assumed that the base station clearly knows the UE's beam failure situation and information for a preferred new beam, so the UE need not separately determine whether to stop the beam failure recovery procedure.

In performing the BFR procedure based on method 1 of the disclosure described above, it may come at issue whether the UE needs to continuously monitor the PDCCH candidates even in the search space configured to monitor before the PRACH as well as the search space indicated by the recoverySearchSpaceID after transmitting the non-contention PRACH for BFR. This is because in this case, the complexity of the UE may increase, and a response to the PRACH may not be received or may be delayed as the monitoring is performed on the previously configured search space.

The UE operating based on method 1 does not stop monitoring the search space configured before the PRACH. It may be necessary to define an operation of the UE related to stopping monitoring of the previously configured search space while monitoring another search space.

In terms of UE complexity, the control session designed a priority rule among search spaces so that the number of blind detections does not exceed the maximum value. The increased number of blind detections on the UE side may be handled by setting a beam failure detection search space (SS-BFR) to have a higher priority SS compared to other search spaces.

Therefore, to address the above-described issues, the UE does not stop monitoring the previously configured search space, but when the number of blind detections exceeds the maximum value, the UE may be configured to preferentially perform blind detection on the search space configured for beam failure detection.

Hereinafter, matters on whether the random access procedure is successful in connection with the above-described beam failure recovery are described below in detail.

There may be two cases of success of the random access procedure for beam failure recovery.

One case is when the UE receives a response to the beam failure recovery request from the base station. The other case is when the beam failure is normally restored.

Regarding the other case, the serving beam quality may be spontaneously restored when the object blocking the serving beam moves away, when the UE rotates to a good Rx beam position to receive the DL signal, or after a beam error occurs over time. When the UE escapes from the beam blocking area (e.g., behind a wall), the quality of the existing CORESET may be spontaneously improved, so that it may be processed as if the random access procedure for beam failure recovery succeeds.

With a similar technical background, the T310 timer is stopped once the virtual BLER of the PDCCH is lower than Q_in threshold (i.e., “out-of-sync” in both LTE and NR) in the RLF recovery procedure. Regarding the multi-beam based operation in a high frequency band, as the beam width of the serving PDCCH becomes narrower, spontaneous recovery may occur more frequently.

Therefore, if the quality of the current serving beam is recovered spontaneously to prevent waste of the UE energy used to transmit the PRACH and search for a response from the base station, the BFR procedure should be stopped.

[Method 2]

Consideration may be given a method for stopping the BFR procedure when the current serving beam quality is restored like in the “in-sync” event of RLF. The method may relate to a method of defining an event of spontaneous recovery of the current serving beam, that is, a beam level “In-synch” event.

Even if the DCI for the PDCCH detected in the SS configured for beam failure detection is successfully decoded, since the virtual BLER is a probability, there is always a possibility that the DCI is successfully decoded depending on the nature of fading so even if the virtual BLER is high. Therefore, it is difficult to say that CORESET has been completely restored.

In this regard, the “in-synch” event in the RLF procedure was defined to reflect a long-term channel condition (i.e., 100 msec). In the case of BFR, this principle should be maintained even though the length of the time window is much shorter than that of RLF.

Given that the current RAN2 specification is written as shown in Table 6 below, method 3 is proposed.

TABLE 6
[... omit..]
1> if notification of a reception of a PDCCH transmission is received from lower layers; and
1> if PDCCH transmission is addressed to the C-RNTI; and
1> if the contention-free Random Access Preamble for beam failure recovery request was
transmitted by the MAC entity:
2> consider the Random Access procedure successfully completed.
[... omit..]

[Method 3]

After the UE transmits the non-contention PRACH for BFR, the physical layer may transmit an indication for completing the beam failure recovery procedure to the MAC layer when one of the following conditions is satisfied.
When the PDCCH is successfully decoded from SS-BFR.
When the PDCCH is successfully decoded from an SS other than SS-BFR, and the virtual BLER of the CORESET related to the SS measured on the time window is less than the threshold Q_in.

[Method 3-A]

After the UE transmits the non-contention PRACH for BFR, the physical layer may send an indication to the MAC layer to complete the beam failure recovery procedure when one of the following conditions is satisfied.
When the PDCCH is successfully decoded from SS-BFR.
When the PDCCH is successfully decoded from an SS other than SS-BFR, and the virtual BLER of the CORESET related to the SS is below the Q_in threshold for a predetermined number of times (at this time, it may be the same as the maximum RRC-configured value, and the BFI is calculated within a certain time).

The method defined in TS38.321 to check BFD may be applied to the “in-synch” state check.

Considering the content defined in TS 38.321, it may be defined to transmit a beam success instance (BSI) to the MAC sublayer when an event in which the hypothetical BLER (for the preconfigured SS/CORESET) falls below a specific value occurs at the physical layer. An example of a specific definition is summarized in Table 7 below.

```
TABLE 7
The MAC entity shall:
1> if beam success instance indication has been received from lower layers:
  2> start or restart the beamSuccessDetectionTimer;
  2> increment BSI_COUNTER by 1;
  2> if BSI_COUNTER >= beamSuccessInstanceMaxCount:
    3> stop the beamFailureRecoveryTimer, if configured;
    3> consider the Beam Failure Recovery procedure successfully completed.
1> if the beamSucessDetectionTimer expires:
  2> set BSI_COUNTER to 0.
```

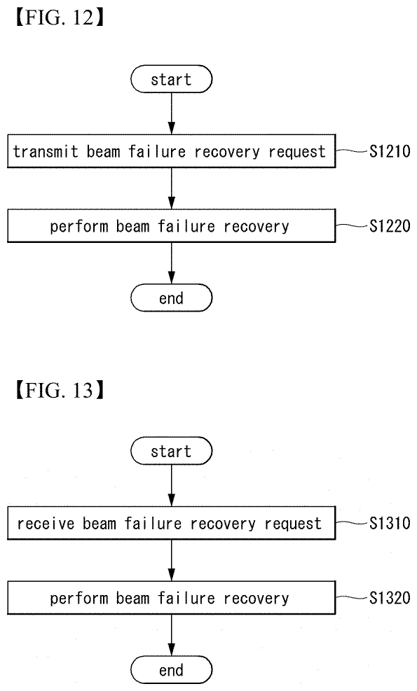

The embodiment of the disclosure discussed above may be specifically applied to a method for recovering a beam failure, which is described below with reference to FIG. 12.

FIG. 12 is a flowchart illustrating a beam failure recovery method according to an embodiment of the disclosure.

Referring to FIG. 12, a beam failure recovery method according to an embodiment of the disclosure may include transmitting a beam failure recovery request (S1210) and performing beam failure recovery (S1220).

In S1210, the UE in a beam failure situation may transmit a beam failure recovery request to the base station. Specifically, the UE may transmit a beam failure recovery request including information on a beam selected from among candidate beams for beam failure recovery.

The beam failure recovery request may be a PRACH resource and preamble configured to be directly or indirectly connected to the selected beam.

In S1220, the UE monitors a response to the beam failure recovery request for the beam failure recovery.

According to an embodiment, when the beam failure recovery request includes the PRACH resource and preamble configured to be directly connected to the selected beam, the UE may monitor the response by performing blind detection on a search space separately RRC-configured for BFR.

According to an embodiment, when the beam failure recovery request includes the PRACH resource and preamble configured to be directly connected to the selected beam, the UE may monitor the response by performing blind detection on the search space and the control resource set (e.g., CORESET0 or CORESET1) configured for general contention PRACH-based random access.

The UE may determine whether to stop step S1220. Specifically, the UE may determine whether to stop the step of performing the beam failure recovery by monitoring the monitoring spaces configured based on one or more preconfigured control resource sets. The UE may stop the step S1220 of performing the beam failure recovery when the beam quality for at least any one meets a predetermined requirement except for the control resource set configured dedicated for beam failure recovery among the one or more control resource sets.

According to an embodiment, it may be carried out when the UE receives control information via any one of the one or more control resource sets. The control information may be downlink control information.

According to an embodiment, the one or more control resource sets may be positioned in a search space other than the search space configured to detect a response to the beam failure recovery request signal from the base station.

According to an embodiment, the beam for at least one except for the control resource set configured dedicated for beam failure recovery among the one or more control resource sets may be a beam corresponding to the control resource set where the control information has been received, at least one beam among all the beams corresponding to the control resource set configured before the beam failure, at least one beam among the beams configured for beam failure detection, or a combination thereof. The beam configured for beam failure detection is a beam configured by a higher layer (RRC) and is different from a beam configured by the control resource set dedicated for beam failure recovery.

According to an embodiment, the quality of the beam may be the hypothetical block error rate (BLER).

The preset requirements may be any one of: 1) when the quality of the beam is maintained below a preset threshold for a predetermined time or longer; 2) when the quality of the beam is continuously detected as below a preset threshold a predetermined number of times or more; and 3) when the quality of the beam is continuously detected as below a preset threshold a predetermined number of times or more within a predetermined time.

According to an embodiment, the predetermined time may be shorter than a time set in the timer (e.g., T310) related to a radio link failure. This has been done so in light of the fact that in the multi-beam-based operation of a high frequency band, spontaneous recovery may occur more frequently as the beam width of the serving PDCCH becomes narrower.

According to an embodiment, the UE may start monitoring for determining whether to stop the step of performing the beam failure recovery at the time of detection of a beam failure, at the time of transmission of the beam failure recovery request, or a specific time after the time of transmission or the time of transmission. The specific time may be set as a specific value in consideration of the monitoring efficiency. The monitoring may be performed by performing blind detection on the search spaces other than the search space configured for beam failure detection among previously configured search spaces.

According to an embodiment, the number of search spaces in which the blind detection is performed may be limited to a predetermined value or less. The predetermined value may be set as a specific value in consideration of the complexity of the UE. When the number of search spaces currently subject to blind detection exceeds the predetermined value, blind detection may be performed preferentially for the search space configured to detect the beam failure. This is to ensure that there is no effect on performing the existing beam failure recovery procedure in monitoring the quality of the beam when the total number of blind detections is limited.

According to an embodiment, when the UE does not receive a response to the beam failure recovery request from the base station, it may be repeatedly performed from S1210. When the preset requirement is met, the UE may stop the operation according to the currently performed step (S1210 or S1220).

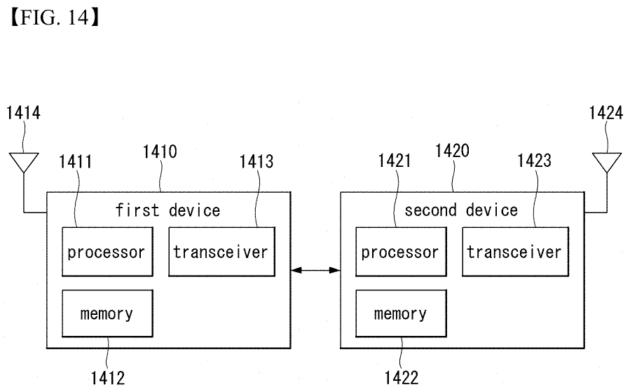

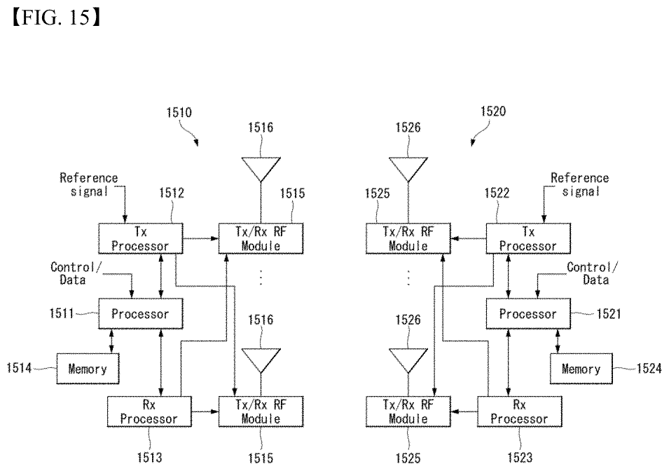

In an implementational aspect, the operation of the UE described above may be specifically implemented by the UE devices 1420 or 1520 shown in FIGS. 14 and 15 of the disclosure. For example, the above-described UE operations may be performed by the processors 1421 and 1521 and/or the radio frequency (RF) units (or modules) 1423 and 1525.

In a wireless communication system, a UE receiving a data channel (e.g., a PDSCH) may include a transmitter for transmitting wireless signals, a receiver for receiving wireless signals, and a processor functionally connected with the transmitter and the receiver. Here, the transmitter and the receiver (or transceiver) may be referred to as a transceiver for transmitting and receiving wireless signals.

For example, the processor may control to allow the UE in the beam failure context to transmit a beam failure recovery request to the base station, monitor a response to the beam failure recovery request, perform the beam failure recovery, monitor the monitoring spaces configured based on one or more control information sets configured in the UE, and determine whether to stop the step of performing the beam failure recovery.

The processor may control to stop the operation of performing the beam failure recovery when the quality of the beam for at least one of the one or more control information sets satisfies a preset requirement.

In the disclosure, when the quality of the existing beam is recovered after the beam failure, the current beam failure recovery procedure is stopped, and if not, the beam failure recovery procedure continues. Therefore, when the quality of the existing beam is recovered after the beam failure, the operation currently being performed for beam failure recovery is stopped, and thus power waste of the UE may be prevented.

Further, the disclosure performs blind detection on an existing search space to determine whether to recover the quality of a beam and additionally considers whether a hypothetical block error rate is not more than a preset threshold and satisfies a predetermined time and a predetermined number of times. Therefore, even when the quality of the beam is temporarily recovered, it is possible to prevent the beam failure recovery procedure from being stopped.

Further, in the disclosure, when the number of search spaces in which blind detection is performed is limited, blind detection is preferentially performed on a search space for monitoring a response to the beam failure recovery request. Therefore, since only blind detection for monitoring the quality of the beam is performed, it is possible to prevent a failure or delay in receipt of a response to the beam failure recovery request.

The beam failure recovery method according to the disclosure may be performed by the base station. This is described below in detail with reference to FIG. 13.

FIG. 13 is a flowchart illustrating a beam failure recovery method according to another embodiment of the disclosure.

Referring to FIG. 13, a beam failure recovery method according to another embodiment of the disclosure may include receiving a beam failure recovery request (S1310) and performing beam failure recovery (S1320).

In S1310, the base station may receive the beam failure recovery request from the UE that detects the beam failure. Specifically, the base station may receive a beam failure recovery request including information on a beam selected from among candidate beams for beam failure recovery.

The beam failure recovery request may be a PRACH resource and preamble configured to be directly or indirectly connected to the selected beam.

In S1320, the base station transmits a response to the beam failure recovery request to the UE for the beam failure recovery.

The base station may determine whether to stop step S1320.

Specifically, the base station may determine whether to stop the step of performing the beam failure recovery by monitoring monitoring spaces configured based on one or more control resource sets configured in the corresponding UE. The base station may stop the step S1320 of performing the beam failure recovery when the beam quality for at least any one meets a predetermined requirement except for the control resource set configured dedicated for beam failure recovery among the one or more control resource sets.

According to an embodiment, one or more control resource sets configured in the UE may be located in a search space other than the search space configured for the UE to detect a response to the beam failure recovery request.

According to an embodiment, the beam for at least one except for the control resource set configured dedicated for beam failure recovery among the one or more control resource sets may be a beam corresponding to the control resource set where the downlink control information has been transmitted, at least one beam among all the beams corresponding to the control resource set configured before the beam failure, at least one beam among the beams configured for beam failure detection, or a combination thereof.

According to an embodiment, the quality of the beam may be the hypothetical block error rate (BLER).

The preset requirements may be any one of: 1) when the quality of the beam is maintained below a preset threshold for a predetermined time or longer; 2) when the quality of the beam is continuously detected as below a preset threshold a predetermined number of times or more; and 3) when the quality of the beam is continuously detected as below a preset threshold a predetermined number of times or more within a predetermined time.

According to an embodiment, the predetermined time may be shorter than a time set in the timer (e.g., T310) related to a radio link failure. This has been done so in light of the fact that in the multi-beam-based operation of a high frequency band, spontaneous recovery may occur more frequently as the beam width of the serving PDCCH becomes narrower.

According to an embodiment, the base station may initiate monitoring to determine whether to stop the step of performing the beam failure recovery at the time when the beam failure recovery request is received or a specific time after the time of reception. The specific time may be set as a specific value in consideration of the monitoring efficiency.

The above-described method may be performed by the base station making a configuration regarding stopping the beam failure recovery in the UE.

In terms of implementation, the above-described method may be implemented by the base stations 1410 and 1510 shown in FIGS. 14 to 15 of the present specification.

In a wireless communication system, a base station transmitting a data channel (e.g., a PDSCH) may include a transmitter for transmitting wireless signals, a receiver for receiving wireless signals, and a processor functionally connected with the transmitter and the receiver. Here, the transmitter and the receiver (or transceiver) may be referred to as a transceiver for transmitting and receiving wireless signals.

For example, the processor may control to allow the UE in the beam failure context to receive a beam failure recovery request from the base station, transmit a response to the beam failure recovery request to the UE, monitor monitoring spaces configured based on one or more control resource sets configured in the UE, and stop the operation for beam failure recovery.

The processor may stop the operation of performing the beam failure recovery when the beam quality for at least any one meets a predetermined requirement except for the control resource set configured dedicated for beam failure recovery among the one or more control resource sets.

Devices to which the Disclosure May Apply

FIG. 14 is a view illustrating a wireless communication device to which the methods proposed in the present specification may be applied according to another embodiment of the disclosure.

Referring to FIG. 14, the wireless communication system may include a first device 1410 and a plurality of second devices 1420 located in an area of the first device 1410.

According to an embodiment, the first device 1410 may be a base station, and the second device 1420 may be a UE, and each may be represented as a wireless device.

The base station 1410 includes a processor 1411, a memory 1412, and a transceiver 1413. The processor 1411 implements the functions, processes or steps, and/or methods proposed above in connection with FIGS. 1 to 13. Wireless interface protocol layers may be implemented by the processor. The memory 1412 is connected with the processor and stores various pieces of information for driving the processor. The transceiver 1413 is connected with the processor to transmit and/or receive wireless signals. Specifically, the transceiver 1413 may include a transmitter that transmits radio signals and a receiver that receives radio signals.

The UE 1420 includes a processor 1421, a memory 1422, and a transceiver 1423.

The processor 1421 implements the functions, processes or steps, and/or methods proposed above in connection with FIGS. 1 to 13. Wireless interface protocol layers may be implemented by the processor. The memory 1422 is connected with the processor and stores various pieces of information for driving the processor. The transceiver 1423 is connected with the processor to transmit and/or receive wireless signals. Specifically, the transceiver 1423 may include a transmitter that transmits radio signals and a receiver that receives radio signals.

The memory 1412 and 1422 may be positioned inside or outside the processor 1411 and 1421 and be connected with the processor 1411 and 1421 via various known means.

The base station 1410 and/or the UE 1420 may include a single or multiple antennas.

The first device 1410 and the second device 1420 according to another embodiment are described.

The first device 1410 may be a base station, a network node, a transmission terminal, a reception terminal, a radio device, a wireless communication device, a vehicle, an autonomous vehicle, a connected car, an unmanned aerial vehicle (UAV) or drone, an artificial intelligence (AI) module, a robot, an augmented reality (AR) device, a virtual reality (VR) device, a mixed reality (MR) device, a hologram device, a public safety device, an MTC device, an IoT device, a medical device, a fintech device (or financial device), a security device, a weather/environment device, or a device related to fourth industrial revolution or 5G service.

The second device 1420 may be a base station, a network node, a transmission terminal, a reception terminal, a radio device, a wireless communication device, a vehicle, an autonomous vehicle, a connected car, an unmanned aerial vehicle (UAV) or drone, an artificial intelligence (AI) module, a robot, an augmented reality (AR) device, a virtual reality (VR) device, a mixed reality (MR) device, a hologram device, a public safety device, an MTC device, an IoT device, a medical device, a fintech device (or financial device), a security device, a weather/environment device, or a device related to fourth industrial revolution or 5G service.

For example, the UE may include a mobile phone, a smart phone, a laptop computer, a digital broadcasting terminal, a personal digital assistants (PDA), a portable multimedia player (PMP), a navigation system, a slate PC, a tablet PC, an Ultrabook, a wearable device, for example, a watch-type terminal (smartwatch), a glass-type terminal (smart glass), or head mounted display (HMD). For example, the HMD may be a display device worn on the head. For example, HMD may be used to implement VR, AR or MR.

For example, the drone may be an unmanned aerial vehicle that may be flown by wireless control signals. For example, the VR device may include a device that implements virtual-world objects or background. For example, the AR device may include a device that connects and implements virtual-world objects or background on real-world objects or background. For example, the MR device may include a device that combines and implements virtual-world objects or background with real-world objects or background. For example, the hologram device may include a device that implements a 360-degree stereoscopic image by recording and reproducing stereoscopic information by utilizing a light interference phenomenon (so-called holography) that occurs when two laser beams meet. For example, the public safety device may include an image relay device or an image device wearable on a user's body. For example, the MTC device and the IoT device may be devices that do not require direct human intervention or manipulation. For example, the MTC device and the IoT device may include a smart meter, a bending machine, a thermometer, a smart light bulb, a door lock, or various sensors. For example, the medical device may be a device used for the purpose of diagnosing, treating, alleviating, treating or preventing a disease. For example, the medical device may be a device used for the purpose of diagnosing, treating, alleviating or correcting an injury or disorder. For example, the medical device may be a device used for the purpose of examining, replacing or modifying a structure or function. For example, the medical device may be a device used for the purpose of controlling pregnancy. For example, the medical device may include a device for treatment, a device for surgery, a device for (in-vitro) diagnosis, a hearing aid or a device for procedure. For example, the security device may be a device installed to prevent possible hazards and maintain safety. For example, the security device may be a camera, CCTV, recorder, or black box. For example, the fintech device may be a device capable of providing financial services such as mobile payment. For example, the fintech device may include a payment device or a point-of-sales (POS) device. For example, the weather/environment device may include a device that monitors or predicts the weather/environment.

The first device 1410 may include at least one or more processors, such as the processor 1411, at least one or more memories, such as the memory 1412, and at least one or more transceivers, such as the transceiver 1413. The processor 1411 may perform the functions, procedures, and/or methods described above. The processor 1411 may perform one or more protocols. For example, the processor 1411 may perform one or more layers of the air interface protocol. The memory 1412 may be connected to the processor 1411 and may store various types of information and/or commands. The transceiver 1413 may be connected to the processor 1411 and be controlled to transmit and receive wireless signals.

The second device 1420 may include at least one processor, such as the processor 1421, at least one memory device, such as the memory 1422, and at least one transceiver, such as the transceiver 1423. The processor 1421 may perform the functions, procedures, and/or methods described above. The processor 1421 may implement one or more protocols. For example, the processor 1421 may implement one or more layers of the air interface protocol. The memory 1422 may be connected to the processor 1421 and may store various types of information and/or commands. The transceiver 1423 may be connected to the processor 1421 and be controlled to transmit and receive wireless signals.

The memory 1412 and/or the memory 1422 may be connected inside or outside the processor 1411 and/or the processor 1421 or may be connected to other processors through various technologies such as wired or wireless connection.

The first device 1410 and/or the second device 1420 may have one or more antennas. For example, the antenna 1414 and/or the antenna 1424 may be configured to transmit and receive wireless signals.

FIG. 15 is a block diagram illustrating another example configuration of a wireless communication device to which methods proposed according to the disclosure are applicable.

Referring to FIG. 15, the wireless communication system includes a base station 1510 and a plurality of UEs 1520 located in the area of the base station. The base station may be expressed as a transmitter, and the UE may be expressed as a receiver, and vice versa. The base station and UE include processors 1511 and 1521, memories 1514 and 1524, one or more Tx/Rx radio frequency (RF) modules 1515 and 1525, Tx processors 1512 and 1522, Rx processors 1513 and 1523, and antennas 1516 and 1526. The processor implements the above-described functions, processes, and/or methods. Specifically, on DL (communication from the base station to the UE), higher layer packets are provided from a core network to the processor 1511. The processor implements L2 layer functions. On DL, the processor is in charge of multiplexing between the logical channel and transport channel, radio resource allocation for the UE, and signaling to the UE. The Tx processor 1512 implements various signal processing functions on the L1 layer (i.e., the physical layer). The signal processing functions allow for easier forward error correction (FEC) in the UE and include coding and interleaving. Coded and modulated symbols are split into parallel streams, and each stream is mapped to an OFDM subcarrier, is multiplexed with a reference signal (RS) in the time and/or frequency domain, and they are then merged together by inverse fast Fourier transform (IFFT), thereby generating a physical channel for carrying time domain OFDMA symbol streams. The OFDM streams are spatially precoded to generate multiple spatial streams. Each spatial stream may be provided to a different antenna 1516 via an individual Tx/Rx module (or transceiver 1515). Each Tx/Rx module may modulate the RF carrier into each spatial stream for transmission. In the UE, each Tx/Rx module (or transceiver 1525) receives signals via its respective antenna 1526. Each Tx/Rx module reconstructs the information modulated with the RF carrier and provides the reconstructed signal or information to the Rx processor 1523. The Rx processor implements various signal processing functions of layer 1. The Rx processor may perform spatial processing on the information for reconstructing any spatial stream travelling to the UE. Where multiple spatial streams travel to the UE, they may be merged into a single OFDMA symbol stream by multiple Rx processors. The Rx processor transforms the OFDMA symbol stream from the time domain to frequency domain using fast Fourier transform (FFT). The frequency domain signal contains an individual OFDMA symbol stream for each subcarrier of the OFDM signal. The reference signal and symbols on each subcarrier are reconstructed and demodulated by determining signal array points that are most probable as transmitted from the baseband signal. Such soft decisions may be based on channel estimations. Soft decisions are decoded and deinterleaved to reconstruct the original data and control signal transmitted by the base station on the physical channel. The data and control signal are provided to the processor 1521.

UL (communication from the UE to the base station) is handled by the base station 1510 in a similar manner to those described above in connection with the functions of the receiver in the UE 1520. Each Tx/Rx module 1525 receives signals via its respective antenna 1526. Each Tx/Rx module provides RF carrier and information to the Rx processor 1523. The processor 1521 may be related to the memory 1524 that stores program code and data. The memory may be referred to as a computer readable medium.

In the disclosure, the wireless device may be a base station, a network node, a transmission terminal, a reception terminal, a radio device, a wireless communication device, a vehicle, an autonomous vehicle, an unmanned aerial vehicle (UAV) or drone, an artificial intelligence (AI) module, a robot, an augmented reality (AR) device, a virtual reality (VR) device, an MTC device, an IoT device, a medical device, a fintech device (or financial device), a security device, a weather/environment device, or a device related to fourth industrial revolution or 5G service. For example, the drone may be an unmanned aerial vehicle that may be flown by wireless control signals. For example, the MTC device and IoT device may be devices that need no human involvement or control and may be, e.g., smart meters, vending machines, thermostats, smart bulbs, door locks, or various sensors. For example, the medical device may be a device for diagnosing, treating, mitigating, or preventing disease or a device used for testing, replacing, or transforming the structure or function, and may be, e.g., a piece of equipment for treatment, surgery, (extracorporeal) diagnosis device, hearing aid, or procedure device. For example, the security device may be a device for preventing possible risks and keeping safe, which may include, e.g., a camera, a CCTV, or a blackbox. For example, the fintech device may be a device capable of providing mobile payment or other financial services, which may include, e.g., a payment device or point-of-sales (PoS) device. For example, the weather/environment device may mean a device that monitors and forecasts weather/environment.

In the disclosure, the UE may encompass, e.g., mobile phones, smartphones, laptop computers, digital broadcast terminals, personal digital assistants (PDAs), portable multimedia players (PMPs), navigation, slate PCs, tablet PCs, Ultrabooks, wearable devices (e.g., smartwatches, smart glasses, or head-mounted displays (HMDs), or foldable devices. For example, the HMD, as a display worn on the human's head, may be used to implement virtual reality (VR) or augmented reality (AR).

The embodiments described above are implemented by combinations of components and features of the disclosure in predetermined forms. Each component or feature should be considered selectively unless specified separately. Each component or feature may be carried out without being combined with another component or feature. Moreover, some components and/or features are combined with each other and can implement embodiments of the disclosure. The order of operations described in embodiments of the disclosure may be changed. Some components or features of one embodiment may be included in another embodiment, or may be replaced by corresponding components or features of another embodiment. It is apparent that some claims referring to specific claims may be combined with another claims referring to the claims other than the specific claims to constitute the embodiment or add new claims by means of amendment after the application is filed.

Embodiments of the disclosure can be implemented by various means, for example, hardware, firmware, software, or combinations thereof. When embodiments are implemented by hardware, one embodiment of the disclosure can be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

When embodiments are implemented by firmware or software, one embodiment of the disclosure can be implemented by modules, procedures, functions, etc. performing functions or operations described above. Software code can be stored in a memory and can be driven by a processor. The memory is provided inside or outside the processor and can exchange data with the processor by various well-known means.

It is apparent to those skilled in the art that the disclosure can be embodied in other specific forms without departing from essential features of the disclosure. Accordingly, the aforementioned detailed description should not be construed as limiting in all aspects and should be considered as illustrative. The scope of the disclosure should be determined by rational construing of the appended claims, and all modifications within an equivalent scope of the disclosure are included in the scope of the disclosure.

1. A method for performing beam failure recovery by a user equipment (UE) in a wireless communication system, the method comprising:
transmitting a beam failure recovery request to a base station by the UE in a beam failure situation; and
performing the beam failure recovery by monitoring a response to the beam failure recovery request, wherein
whether to stop performing the beam failure recovery is determined by monitoring monitoring spaces configured based on one or more control resource sets configured for the UE, and wherein
performing the beam failure recovery is stopped when a beam quality for at least one except for a control resource set configured only for beam failure recovery among the one or more control resource sets meets a predetermined requirement.

2. The method of claim 1, wherein whether to stop performing the beam failure recovery is determined when control information is received via any one of the one or more control resource sets.

3. The method of claim 2, wherein the one or more control resource set configured for the UE are located in a search space other than a search space configured to detect the response to the beam failure recovery request signal from the base station.

4. The method of claim 2, wherein the control information is downlink control information.

5. The method of claim 2, wherein a beam for at least one except for the control resource set configured only for the beam failure recovery among the one or more control resource sets is a beam corresponding to a control resource set receiving the control information, at least one beam among all beams corresponding to a control resource set configured before the beam failure, at least one beam among beams configured for beam failure detection, or a combination thereof.

6. The method of claim 1, wherein the beam quality is a hypothetical block error rate (BLER).

7. The method of claim 1, wherein the predetermined requirement is any one of:
1) when the beam quality remains below a predetermined threshold for a predetermined time;
2) when the beam quality is detected as below the predetermined threshold continuously a predetermined number of times or more; or
3) when the beam quality is detected as below the predetermined threshold continuously the predetermined number of times or more within the predetermined time.

8. The method of claim 7, wherein the predetermined time is shorter than a time set in a timer related to a radio link failure.

9. The method of claim 1, wherein the monitoring for determining whether to stop performing the beam failure recovery is started at a time of detection of a beam failure, at a time of transmission of the beam failure recovery request, or a specific time after the time of detection or the time of transmission.

10. The method of claim 9, wherein
in performing the beam failure recovery, the response is monitored by performing blind detection on a search space configured to detect the beam failure, and wherein
the monitoring for determining whether to stop performing the beam failure recovery is performed by performing blind detection on search spaces other than the search space configured to detect the beam failure among search spaces configured in the UE.

11. The method of claim 10, wherein a number of the search spaces where the blind detection is performed is limited to a predetermined value, and
wherein when the number of search spaces currently subject to blind detection exceeds the predetermined value, the blind detection may be performed preferentially on the search space configured to detect the beam failure.

12. The method of claim 11, wherein
in performing the beam failure recovery, if no response to the beam failure recovery request is received, the steps are repeatedly performed from transmitting the beam failure recovery request, and wherein
when the predetermined requirement is met, the step currently being performed is stopped.

13. A UE performing beam failure recovery in a wireless communication system, the UE comprising:
a transceiver transmitting/receiving a radio signal;
a memory; and
a processor connected with the transceiver and the memory, wherein
the processor is configured to:
transmit a beam failure recovery request to a base station in a beam failure situation;
perform the beam failure recovery by monitoring a response to the beam failure recovery request;
determine whether to stop performing the beam failure recovery by monitoring monitoring spaces configured based on one or more control resource sets configured for the UE; and
stop performing the beam failure recovery when a beam quality for at least one except for a control resource set configured only for the beam failure recovery among the one or more control resource sets according to a result of the monitoring meets a predetermined requirement.

14. The UE of claim 13, wherein
the processor is configured to determine whether to stop performing the beam failure recovery when control information is received via any one of the one or more control resource sets.

15. A device performing beam failure recovery in a wireless communication system, the device comprising:
a memory; and a processor connected with the memory, wherein
the processor is configured to:
transmit a beam failure recovery request to a base station in a beam failure situation;
perform the beam failure recovery by monitoring a response to the beam failure recovery request;
determine whether to stop performing the beam failure recovery by monitoring monitoring spaces configured based on one or more control resource sets configured for the UE; and
stop performing the beam failure recovery when a beam quality for at least one except for a control resource set configured only for the beam failure recovery among the one or more control resource sets according to a result of the monitoring meets a predetermined requirement.
